(19) United States
(12) Patent Application Publication
(10) Pub. No.: US 2024/0249460 A1
(43) Pub. Date: Jul. 25, 2024

(54) SYSTEM AND METHOD FOR SEMI-SUPERVISED VIDEO-DRIVEN FACIAL ANIMATION TRANSFER

(71) Applicants: Lucio Dorneles MOSER, Vancouver (CA); José Mário Figueiredo SERRA, Vancouver (BC); Mark Douglas John WILLIAMS, Vancouver (CA)

(72) Inventors: Lucio Dorneles MOSER, Vancouver (CA); José Mário Figueiredo SERRA, Vancouver (BC); Mark Douglas John WILLIAMS, Vancouver (CA)

(73) Assignee: Digital Domain Virtual Human (US), Inc., Los Angeles, CA (US)

(21) Appl. No.: 18/594,470

(22) Filed: Mar. 4, 2024

Related U.S. Application Data
(63) Continuation of application No. PCT/CA2022/051306, filed on Aug. 29, 2022.
(60) Provisional application No. 63/331,218, filed on Apr. 14, 2022.
(60) Provisional application No. 63/242,484, filed on Sep. 9, 2021.

(51) Int. Cl. G06T 13/40; G06T 17/00; G06V 10/82; G06V 40/16

(52) U.S. Cl. CPC G06T 13/40; G06T 17/00; G06V 10/82; G06V 40/174

(57) ABSTRACT

A method transfers facial expressions from a performance input to a 3D CG character. The method comprises: providing an inference engine trained for receiving, as input, images exhibiting facial expressions and outputting, for each input image, a 3D CG representation of a CG character having a character facial expression corresponding to that of the input image; receiving performance input, the performance input comprising, or convertible to, one or more performance input images, each of the one or more performance input images exhibiting a performance facial expression; and inputting the performance input images to the inference engine to thereby infer, for each of performance input image, a corresponding 3D CG representation of an output CG character having an inferred character facial expression corresponding to the performance facial expression of the performance input image.

### REFERENCE TO RELATED APPLICATIONS

This application is a continuation of Patent Cooperation Treaty (PCT) application No. PCT/CA2022/051306 having an international filing date of 29 Aug. 2022 which in turn claims priority from, and for the purposes of the United States the benefit under 35 USC 119 in relation to, U.S. application No. 63/242,484 filed 9 Sep. 2021 and U.S. application No. 63/331,218 filed 14 Apr. 2022. All of the applications referred to in this paragraph are hereby incorporated herein by reference.

### TECHNICAL FIELD

This application is directed to systems and methods for computer animation of faces. More particularly, this application is directed to systems and methods for facial animation transfer.

### BACKGROUND

There is a desire in the field of computer-generated (CG) animation of faces to perform tasks such as facial motion capture and facial motion retargeting. Facial motion capture typically involves digital recording to a facial performance of a performer (actor) and there is a desire, within facial motion capture, to digitally capture as much detail as possible about the idiosyncrasies of the performer's facial performance. Facial motion retargeting may be described as the process of adapting actor-specific facial motion data into a digital (CG) character. Often, the CG character will have a different physiognomy and/or a different range of motion than the actor from whom the motion data is obtained. There is also a desire to use facial motion retargeting techniques to transfer existing performances between different characters, such as when there is no consistent underlying animation rig between the characters (e.g. to re-use animation data from one character to another). Typically, prior art facial motion capture and facial motion retargeting techniques used in CG facial animation require complicated set-ups and require time consuming iterations involving human artists.

There is a general desire in the field of computer-generated (CG) animation of faces to perform tasks such as facial motion capture and facial motion retargeting that improve upon prior art techniques.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a method, performed on a computer, for transferring facial expressions from a performance input to a three-dimensional (3D) computer graphics (CG) character. The method comprises: providing an inference engine trained for receiving, as input, images exhibiting facial expressions and outputting, for each input image, a 3D CG representation of a CG character having a character facial expression corresponding to the facial expression of the input image; receiving performance input, the performance input comprising, or convertible to, one or more performance input images, each of the one or more performance input images exhibiting a performance facial expression; and inputting the performance input images to the inference engine to thereby infer, for each of the performance input images, a corresponding 3D CG representation of an output CG character having an inferred character facial expression corresponding to the performance facial expression of the performance input image.

The inference engine may comprise an encoder that is part of an autoencoder. The encoder may be trained to receive, as input, images exhibiting facial expressions and to compress the input images into corresponding latent codes.

The encoder may be trained using, as training input, training images exhibiting facial expressions from multiple identities and the encoder may comprise the same trained parameters for each of the multiple identities.

At least one of the multiple identities may comprise the output CG character.

At least one of the multiple identities may comprise a source CG character that is different from the output CG character.

At least one of the multiple identities may comprise an actor (i.e. a real person as opposed to a CG character).

The performance input images may be from an input identity that is different from the multiple identities used to train the encoder.

The inference engine may comprise a latent-to-3D network. The latent-to-3D network may be trained to receive, as input, latent codes (e.g. generated by the encoder or by the encoder in combination with a portion of a decoder that forms part of the autoencoder) and to output, for each latent code, a corresponding 3D CG representation of the output CG character.

At least a first portion of the latent-to-3D network may comprise trained parameters that are specific to the output CG character.

At least a second portion of the latent-to-3D network may comprise the same trained parameters for each of the multiple identities.

The second portion of the latent-to-3D network may comprise at least a portion of a decoder that is part of the autoencoder.

The second portion of the latent-to-3D network may be trained to receive, as input, latent codes (e.g. generated by the encoder or by the encoder in combination with a portion of a decoder that forms part of the autoencoder). The first portion of the latent-to-3D network may comprise an image-to-geometry neural network which may be trained to receive, as input, output from the second portion of the latent-to-3D network and to output corresponding 3D CG representations of the output CG character.

The image-to-geometry neural network may be trained at least in part using, as training input, 3D CG training representations (e.g. blendshape weights and/or the like) of the output CG character exhibiting facial expressions of the output CG character.

The first portion of the latent-to-3D network may comprise a character-specific image-to-image decoder which is part of the autoencoder and which is trained to receive, as input, output from the second portion of the latent-to-3D network and to output corresponding images of the output CG character.

The character-specific image-to-image decoder may be trained at least in part using, as training input, image-to-image training input comprising, or convertible to, a plurality of training input images of the output CG character.

The inference engine may comprise an image-to-image model. The image-to-image model may comprise a first instance of the encoder for receiving, as input, images exhibiting facial expressions and compressing the input images into corresponding latent codes. The image-to-image model may also comprise a first instance of the second portion of the latent-to-3D network for receiving, as input, latent codes generated by the first instance of the encoder. The image-to-image model may also comprise the character-specific image-to-image decoder for receiving, as input, output from the first instance of the second portion of the latent-to-3D network and outputting corresponding images of the output CG character. The inference engine may also comprise a second instance of the encoder for receiving, as input, images of the output CG character from the character-specific image-to-image decoder and compressing the images of the output CG character into corresponding latent codes. The inference engine may also comprise a second instance of the second portion of the latent-to-3D network for receiving, as input, latent codes generated by the second instance of the encoder. The inference engine may also comprise the image-to-geometry neural network for receiving, as input, output from the second instance of the second portion of the latent-to-3D network and outputting corresponding 3D CG representations of the output CG character.

The performance input may comprise the one or more performance input images. Each of the one or more performance input images may exhibit the performance facial expression of a human actor.

The performance input images may comprise facial markers.

The inference engine may remove the facial markers.

The inference engine may be trained using, as input, training images exhibiting facial expressions from multiple training identities. The performance input may comprise the one or more performance input images. Each of the one or more performance input images may exhibit the performance facial expressions of a human actor. The human actor may be different from the multiple training identities. The performance input images may comprise facial markers. The inference engine may remove the facial markers.

The one or more performance images may be captured using a single camera, one of multiple cameras of a head-mounted camera (HMC) apparatus or multiple cameras of a HMC apparatus.

The one or more performance images may comprise frames of a video sequence.

The performance input may comprise the one or more performance input images. Each of the one or more performance input images may comprise a rendered image of a CG performance character exhibiting the performance facial expression.

The inference engine may be trained using, as input, training images exhibiting facial expressions from multiple training identities. The performance input may comprise the one or more performance input images. Each of the one or more performance input images may comprise a rendered image of a CG character exhibiting the performance facial expression, the CG performance character may be different from the multiple training identities.

The performance input may comprise one or more poses/frames of a 3D CG representation of a CG performance character. The method may also comprise rendering the one or more poses/frames of the 3D CG representation of the CG performance character to generate the one or more performance input images. Each of the one or more performance input images may exhibit the performance facial expression of the CG performance character.

The inference engine may be trained using, as input, training images exhibiting facial expressions from multiple training identities. The performance input may comprise one or more poses/frames of a 3D CG representation of a CG performance character. The method may also comprise rendering the one or more poses/frames of the 3D CG representation of the CG performance character to generate the one or more performance input images. Each of the one or more performance input images may exhibit the performance facial expression of the CG performance character. The CG performance character may be different from the multiple training identities.

For each of the performance input images, the corresponding 3D CG representation of the output CG character may comprise a set of weights for a blendshape decomposition corresponding to the output CG character.

The blendshape decomposition may comprise a principal component analysis (PCA) decomposition. The set of weights may comprise a set of PCA weights.

For each of the performance input images, the corresponding 3D CG representation of the output CG character may comprise at least one of: a set of data compression parameters used in a data compression technique corresponding to the output CG character and a set of compression parameters used in a neural network for parameterizing poses of the corresponding output CG character. Each set of data compression parameters may be usable to reconstruct 3D vertex positions of the output CG character. Each set of compression parameters may be usable to reconstruct 3D vertex positions of the output CG character.

Providing the inference engine may comprise training the inference engine.

Training the inference engine may comprise training the inference engine using training input. The training input may comprise source training input. The source training input may comprise or be convertible to source training images exhibiting facial expressions of one or more source identities. The training input may also comprise 3D CG training representations of the output CG character exhibiting facial expressions of the output CG character.

Each of the one or more performance images may exhibit a performance facial expression of a performance identity. The performance identity may be different from the one or more source identities and may be different from the output CG character.

The source training input may comprise, for at least one of the one or more source identities, a corresponding set of source training images. Each of the corresponding set of source training images may exhibit the facial expression of a human actor.

The source training images may comprise facial markers.

Training the inference engine may comprise removing the facial markers.

For the at least one of the one or more source identities, the corresponding set of training images may be captured using a single camera, one of multiple cameras of a head-mounted camera (HMC) apparatus or multiple cameras of a HMC apparatus.

For the at least one of the one or more source identities, the corresponding set of training images may comprise frames of a video sequence.

The source training input may comprise, for at least one of the one or more source identities, a corresponding set of source training images rendered from a 3D representation of a CG source character. Each of the corresponding set of source training images may exhibit the facial expression of the CG source character.

For at least one of the one or more source identities the source training input may comprise a set of poses/frames of a 3D representation of a source CG character. For at least one of the one or more source identities training the inference engine may comprise rendering the set of poses/frames of the 3D representation of the source CG character to generate a corresponding set of source training images. For at least one of the one or more source identities each of the corresponding set of source training images may exhibit the facial expression of the source CG character.

The 3D CG training representations of the output CG character may comprise a set of training poses/frames of the 3D CG representations of the output CG character. Training the inference engine may comprise rendering the set of training poses/frames of the 3D CG representations of the output CG character to generate a corresponding set of output character training images. Each of the corresponding set of output character training images may exhibit the facial expression of the output CG character.

Training the inference engine may comprise training an image-to-image model using the source training images and the set of output character training images. The image-to-image model, when trained, may receive, as input, images exhibiting facial expressions and may output corresponding images exhibiting facial expressions of the output CG character.

Training the inference engine may comprise training one or more additional image-to-image models using the source training images and the set of output character training images. Each of the one or more additional image-to-image models, when trained, may receive, as input, images exhibiting facial expressions and may output corresponding images exhibiting facial expressions of the one or more source identities.

Training the image-to-image model may comprise training a plurality of autoencoders. The plurality of autoencoders may comprise an autoencoder for each of the one or more source identities and for the output CG character. Each autoencoder may comprise an encoder which, when trained, is capable of converting images exhibiting facial expressions to corresponding latent codes. Each autoencoder may also comprise a decoder which, when trained, is capable of converting latent codes to corresponding images exhibiting facial expressions of one of the one or more source identities or the output CG character.

Each autoencoder may comprise a shared portion and an identity-specific portion. The shared portion may comprise shared trainable parameters that are the same across the plurality of autoencoders. The identity-specific portions of the autoencoders may each comprise identity-specific trainable parameters that are unique for each of the plurality of autoencoders.

The shared portion may include the encoder of each of the autoencoders.

The shared portion may include one or more initial layers of the decoder of each of the plurality of autoencoders.

Training the plurality of autoencoders may comprise, for each autoencoder inputting to the autoencoder the source training images corresponding to one of the one or more source identities or the output character training images of the output CG character. Training the plurality of autoencoders may also comprise, for each autoencoder causing the encoder of the autoencoder to compress the input source training images or the output character training images into corresponding latent codes. Training the plurality of autoencoders may also comprise, for each autoencoder causing the decoder of the autoencoder to reconstruct reconstructed images corresponding to the latent codes.

Training the plurality of autoencoders may comprise, for each autoencoder, augmenting the source training images or the output character training images prior to inputting the source training images or the output character training images to the autoencoder.

Augmenting the source training images or the output character training images may comprise one or more of translation, rotation, scaling and grid distortion.

Augmenting the source training images or the output character training images may comprise editing factors of variation of the source training images or the output character training images.

Training the plurality of autoencoders may comprise, for each autoencoder, generating image-losses (IL) based on a IL difference metric. The IL difference metric may be between the source training images corresponding to one of the one or more source identities or the output character training images of the output CG character, as optionally augmented in a manner that is the same as the augmentation of the source training images or the output character training images prior to inputting the source training images or the output character training images to the autoencoder or in a manner that is different than the augmentation of the source training images or the output character training images prior to inputting the source training images or the output character training images to the autoencoder and the corresponding reconstructed images reconstructed by the autoencoder.

The IL difference metric may comprise one or more of a criterion function based on least absolute deviation (L1 norm) and a criterion function based on a structural similarity index measure (SSIM).

Training the plurality of autoencoders may comprise, for each autoencoder, generating cycle-consistency-loss (CCL) losses based on a CCL difference metric between the latent codes generated by the encoder of the autoencoder based on the input source training images or the output character training images, as optionally augmented and reconstructed latent codes. The reconstructed latent codes may be generated by the encoder of the autoencoder based on reconstructed images reconstructed by a different one of the plurality of autoencoders.

Training the plurality of autoencoders may comprise, for each autoencoder, generating cycle-consistency-loss (CCL) losses based on a CCL difference metric between an intermediate output generated by the encoder of the autoencoder and a shared portion of a decoder of the autoencoder based on the input source training images or the output character training images, as optionally augmented and reconstructed intermediate output. The reconstructed intermediate output may be generated by the encoder of the autoencoder and the shared portion of the decoder of the autoencoder based on reconstructed images reconstructed by a different one of the plurality of autoencoders.

The different one of the plurality of autoencoders may be randomly selected from among the different ones of the plurality of autoencoders.

The CCL difference metric may comprise one or more of a criterion function based on a mean square error (MSE) and a criterion function based on a least square error (L2 norm).

Training the plurality of autoencoders may comprise, for each autoencoder, generating latent invariance loss (LIL) losses based on an LIL difference metric between the latent codes generated by the encoder of the autoencoder based on the input source training images or the output character training images, as optionally augmented and latently augmented latent codes. The latently augmented latent codes may be generated by the encoder of the autoencoder based on input source training images or the output character training images, as optionally augmented, that have undergone latent invariance augmentation. Latent invariance augmentation may comprise editing one or more factors of variation of the source training images or the output character training images, as optionally augmented, prior to inputting the source training images or the output character training images to the encoder of the autoencoder.

The LIL difference metric may comprise one or more of a criterion function based on a mean square error (MSE) and a criterion function based on a least square error (L2 norm)

A number of the plurality of autoencoders may be N. Training the plurality of autoencoders may comprise performing a plurality of successive sets of N iterations of a batch loop. Each iteration of the batch loop may correspond to one of the plurality of autoencoders. Each iteration of the batch loop may comprise selecting a sample of k training images from among the source training images or the set of output character training images corresponding to the one of the autoencoders. Each iteration of the batch loop may also comprise determining at least one loss for the one of the autoencoders based on the sample of k training images. Each iteration of the batch loop may also comprise determining one or more loss gradients for each of the shared and identity-specific trainable parameters for the one of the autoencoders based on the at least one loss.

Determining at least one loss for the one of the autoencoders may comprise inputting to the one of the autoencoders each of the sample of k training images. Determining at least one loss for the one of the autoencoders may also comprise causing the encoder of the one of the autoencoders to compress each of the sample of k training images into a corresponding latent code. Determining at least one loss for the one of the autoencoders may also comprise causing the decoder of the one of the autoencoders to reconstruct a reconstructed image for each of the latent codes.

Determining at least one loss for the one of the autoencoders may comprise augmenting the sample of k training images prior to inputting the sample of k training images to the one of the autoencoders.

Augmenting the sample of k training images may comprise one or more of translation, rotation, scaling and grid distortion.

Determining at least one loss for the one of the autoencoders may comprise, for each of the sample of k training images, generating an image-loss (IL) based on a IL difference metric. The IL difference metric may be between the training image, as optionally augmented in a manner that is the same as the augmentation of the training image prior to inputting the training image to the one of the autoencoders or in a manner that is different than the augmentation of the training image prior to inputting the training image to the one of the autoencoders and a corresponding reconstructed image reconstructed by the one of the autoencoders.

In each iteration of the batch loop, the IL loss may be accumulated (e.g. added or averaged) over the sample of k training images.

Determining the one or more loss gradients for each of the shared and identity-specific trainable parameters for the one of the autoencoders may comprise determining a loss gradient for each of the shared and identity-specific trainable parameters based on the accumulated IL loss.

Determining at least one loss for the one of the autoencoders may comprise, for each of the sample of k training images generating a cycle-consistency-loss (CCL) loss based on a CCL difference metric between a corresponding latent code generated by the encoder of the one of the autoencoders based on training image, as optionally augmented and a reconstructed latent code. The reconstructed latent code may be generated by the encoder of the one of the autoencoders based on a reconstructed image reconstructed by a different one of the plurality of autoencoders.

Determining at least one loss for the one of the autoencoders may comprise, for each of the sample of k training images generating a cycle-consistency-loss (CCL) loss based on a CCL difference metric between a corresponding intermediate output generated by the encoder and a shared portion of a decoder of the one of the autoencoders based on training image, as optionally augmented and a reconstructed intermediate output. The reconstructed intermediate output may be generated by the encoder and the shared portion of the decoder of the one of the autoencoders based on a reconstructed image reconstructed by a different one of the plurality of autoencoders.

In each iteration of the batch loop, the CCL loss may be accumulated (e.g. added or averaged) over the sample of k training images.

Determining the one or more loss gradients for each of the shared and identity-specific trainable parameters for the one of the autoencoders may comprise determining a loss gradient for each of the shared trainable parameters based on the accumulated CCL loss.

The method may comprise at least one of: adding the loss gradient for each of the shared trainable parameters based on the accumulated IL loss and the loss gradient for each of the shared trainable parameters based on the accumulated CCL loss; and adding the accumulated IL loss and the accumulated CCL loss to generate a total accumulated loss and determining the one or more loss gradients for each of the shared trainable parameters based on the total accumulated loss.

Determining at least one loss for the one of the autoencoders may comprise, for each of the sample of k training images generating a latent invariance loss (LIL) based on an LIL difference metric between a corresponding latent code generated by the encoder of the one of the autoencoders based on the training image, as optional augmented and a latent code generated by the encoder of the one of the autoencoders based on the training image, as optionally augmented, that has been augmented to edit one or more factors of variation of the training image.

In each iteration of the batch loop, the LIL loss may be accumulated (e.g. added or averaged) over the sample of k training images.

Determining the one or more loss gradients for each of the shared and identity-specific trainable parameters for the one of the autoencoders may comprise determining a loss gradient for each of the shared trainable parameters based on the accumulated LIL loss.

The method may comprise at least one of: adding the loss gradient for each of the shared trainable parameters based on the accumulated IL loss, the loss gradient for each of the shared trainable parameters based on the accumulated CCL loss and the loss gradient for each of the shared trainable parameters based on the LIL loss; and adding the accumulated IL loss, the accumulated CCL loss and the accumulated LIL loss to generate a total accumulated loss and determining the one or more loss gradients for each of the shared trainable parameters based on the total accumulated loss.

After each set of N iterations of the batch loop, the shared and identity-specific trainable parameters may be updated based on the loss gradients.

After each set of N iterations of the batch loop, the loss gradients for the shared trainable parameters determined in each iteration of the batch loop may be accumulated (added or averaged).

The method may comprise, after each set of N iterations of the batch loop updating the identify-specific trainable parameters based on the loss gradients. The method may also comprise, after each set of N iterations of the batch loop updating the shared trainable parameters based on the accumulated loss gradients for the shared trainable parameters.

The method may comprise after updating the trainable and identity-specific trainable parameters, resetting the gradients prior to a next one of the plurality of successive sets of N iterations of a batch loop.

Training the inference engine may comprise augmenting the training poses/frames in the set of training poses/frames of the 3D CG representations of the output CG character. Rendering the set of training poses/frames of the 3D CG representations of the output character may comprise rendering the augmented training poses/frames of the 3D CG representations of the output CG character to generate the corresponding set of output character training images.

Augmenting the training poses/frames in the set of poses/frames of the 3D CG representations of the output CG character may comprise applying one or more head orientation transforms to the set of training poses/frames of the 3D CG representations of the output CG character.

The head orientation transforms may be based at least in part on samples of head orientations derived from the source training images.

The head orientation transforms may be generated randomly from among a set of samples of head orientations derived from the source training images.

Augmenting the training poses/frames in the set of training poses/frames of the 3D CG representations of the output CG character may comprise applying augmentations. Augmentations may comprise one of more of: eye transformations, variations in lighting, variations in background (color, luminosity and/or the like), occlusions, lens distortions and field of view augmentations.

Augmenting the training poses/frames in the set of training poses/frames of the 3D CG representations of the output CG character may comprise applying one or more augmentations that are based at least in part on information sampled from the source training images.

Augmenting the training poses/frames in the set of training poses/frames of the 3D CG representations of the output CG character may comprise applying one or more augmentations that are, at least partially, random.

Training the inference engine may comprise training an image-to-geometry model using the set of training poses/frames of the 3D CG representations of the output CG character and the corresponding output character training images. The image-to-geometry model, when trained, may receive, as input, images exhibiting facial expressions of the output CG character and may output corresponding 3D CG representations of the output CG character.

The image-to-geometry model may comprise an image-to-geometry neural network.

Training the inference engine may comprise training an image-to-geometry model using the set of training poses/frames of the 3D CG representations of the output CG character and the corresponding output character training images. The image-to-geometry model, when trained, may receive, as input, images exhibiting facial expressions of the output CG character and may output corresponding 3D CG representations of the output CG character. The image-to-geometry model may comprise the shared portion of the plurality of autoencoders. The shared portion of the plurality of autoencoders may comprise the shared trainable parameters that are the same across the plurality of autoencoders. The image-to-geometry model may also comprise an image-to-geometry neural network.

The inference engine may comprise the autoencoder corresponding to the output CG character for receiving performance input images, and for each performance input image, outputting a corresponding image of the output CG character exhibiting the performance facial expression. The inference engine may also comprise the shared portion of the plurality of autoencoders that may comprise the shared trainable parameters that are the same across the plurality of autoencoders for receiving the images of the output CG character. The inference engine may also comprise the image-to-geometry neural network for receiving output from the shared portion of the plurality of autoencoders and, for each image of the output CG character received by the shared portion of the plurality of autoencoders, outputting the corresponding 3D CG representation of the output CG character having the inferred character facial expression corresponding to the performance facial expression of the performance image.

The inference engine may comprise the shared portion of the plurality of autoencoders that may comprise the shared trainable parameters that are the same across the plurality of autoencoders for receiving performance input images. The inference engine may comprise the image-to-geometry neural network for receiving output from the shared portion of the plurality of autoencoders and, for each performance input image received by the shared portion of the plurality of autoencoders, outputting the corresponding 3D CG representation of the output CG character having the inferred character facial expression corresponding to the performance facial expression of the performance image.

The image-to-geometry neural network may comprise a fully connected neural network.

The image-to-geometry neural network may comprise linear activation functions.

The set of training poses/frames of the 3D CG representations of the output CG character may comprise, for each training pose/frame, a set of weights for a blendshape decomposition corresponding to the output CG character. Training the image-to-geometry model may comprise at least one of: performing the blendshape decomposition to determine the weights for each training pose/frame and receiving the blendshape decomposition and the weights for each training pose/frame.

The blendshape decomposition may comprise a principal component analysis (PCA) decomposition and the set of weights may comprise a set of PCA weights.

The set of training poses/frames of the 3D CG representations of the output CG character may comprise, for each training pose/frame, at least one of: a set of data compression parameters used in a data compression technique corresponding to the output CG character, each set of data compression parameters usable to reconstruct 3D vertex positions of the output CG character; and a set of neural network parameters used in a neural network for parameterizing poses of the corresponding output CG character, each set of neural network parameters usable to reconstruct 3D vertex positions of the output CG character.

Another aspect of the invention involves performing a method on a computer having any of the features described herein iteratively until it is determined that the 3D CG character is sufficient.

The method may comprise integrating the performance input wholly or partially into training data of the inference engine. Training data may comprise a 3D representation of a CG performance character.

Another aspect of the invention provides a method, performed on a computer, for training an inference engine to transfer facial expressions from a performance input to a three-dimensional (3D) computer graphics (CG) character, the performance input comprising, or convertible to, one or more performance input images, each of the one or more performance input images exhibiting a performance facial expression, the inference engine, when trained, capable of inferring, for each performance input images, a corresponding 3D CG representation of an output CG character having an inferred character facial expression corresponding to the performance facial expression of the performance input image, the method comprising: training the inference engine using training input, the training input comprising: source training input comprising, or convertible to, source training images exhibiting facial expressions of one or more source identities; and 3D CG training representations of the output CG character exhibiting facial expressions of the output CG character.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A is a broad schematic depiction of a method for facial animation transfer of facial expressions from one or more actor performances to one or more output 3D CG character representations according to a particular embodiment. FIG. 1B is a broad schematic depiction of a “character retargeting” method for facial animation transfer of facial expressions from one or more 3D CG source characters to one or more output 3D CG character representations according to a particular embodiment. FIG. 1C depicts an exemplary system for performing one or more methods described herein (e.g. the methods of FIG. 1A and FIG. 1B) according to a particular embodiment.

FIGS. 2A and 2B (collectively FIG. 2) are a schematic depiction of a method for preparing the input data for an implementation of the FIG. 1A facial animation transfer method having a single set of actor input images and a single CG character dataset according to a particular embodiment.

FIG. 3A is a schematic depiction of a training scheme showing the computation of criterion functions (IL CCL, LIL criterion functions) for training the image-to-image model for an implementation of the FIG. 1A facial animation transfer method having a single set of actor input images and a single CG character dataset according to a particular embodiment. FIG. 3B is a schematic depiction of a method for training the image-to-image model for an implementation of the FIG. 1A facial animation transfer method having a plurality N of sets of actor input images and/or CG character datasets and/or an implementation of the FIG. 1B CG character retargeting method having a plurality of N sets of source CG character datasets and/or CG character datasets according to a particular embodiment.

FIG. 4A is a schematic depiction of a training scheme showing the computation of a criterion function for training the image-to-geometry model for one CG character/identity for the FIG. 1A facial animation transfer method and/or the FIG. 1B character retargeting method according to a particular embodiment. FIG. 4B is a schematic depiction of a method for training the image-to-geometry model for one CG character/identity for the FIG. 1A facial animation transfer method and/or the FIG. 1B character retargeting method according to a particular embodiment.

FIG. 5 is a schematic depiction of a method for inferring one 3D CG character representation corresponding to performance input that may be used to implement the performance image preparation and image-to-geometry inference for the FIG. 1A facial animation transfer method and/or for the FIG. 1B character retargeting method for one CG character/identity according to a particular embodiment.

FIG. 6A is a schematic depiction of a method for the verification or iterative refinement of the FIG. 1A facial animation transfer method according to a particular example embodiment. FIG. 6B is a schematic depiction of a method for the verification or iterative refinement of the FIG. 1B character retargeting method according to a particular example embodiment.

FIGS. 7A-7G (collectively, FIG. 7) show experimental results obtained using the FIG. 1A facial animation transfer method.

FIG. 8 shows experimental results obtained using the FIG. 1A facial animation transfer method for a circumstance where a single CG character (single CG performance dataset) was trained along with training actor images from twelve different actors.

FIGS. 9A-9G (collectively, FIG. 9) show experimental results obtained using the FIG. 1A facial animation transfer method where the performance input comprises actor images obtained from a previously unseen actor and a comparison of these results to prior art techniques.

FIGS. 10A-10F (collectively, FIG. 10) show experimental results for the use of the FIG. 1B character retargeting method having one CG source character dataset and one CG character dataset and a comparison of these results to prior art techniques.

FIGS. 11A-11E (collectively, FIG. 11) show experimental results for modifying the FIG. 1A facial animation transfer method by varying the surface shader used for rendering CG character images during training.

FIGS. 12A-12E (collectively, FIG. 12) show experimental results for modifying the FIG. 1A facial animation transfer method by varying the eye gaze directions used for rendering CG character images during training.

FIGS. 13A-13C (collectively, FIG. 13) show experimental results for modifying the FIG. 3A training scheme to remove the CCL loss criteria.

FIGS. 14A-14C (collectively, FIG. 14) show experimental results for modifying the location of the CCL loss functions in the FIG. 3A training scheme.

FIGS. 15A-15E (collectively, FIG. 15) show experimental results for modifying the FIG. 4A image-to-geometry training scheme by varying the inputs to and characteristics of the image-to-geometry neural network that forms part of the image-to-geometry model.

FIGS. 16A-16D (collectively, FIG. 16) show experimental results for modifying the FIG. 5A inference method to remove the latent CG projection.

FIGS. 17A-17D (collectively, FIG. 17) show experimental results (including intermediate results) obtained using the FIG. 1A facial animation transfer method.

FIGS. 18A-18H (collectively FIG. 18) show the results of intermediate steps of the FIG. 1A facial animation transfer method.

FIGS. 19A-19H (collectively FIG. 19) show the results of intermediate steps of the FIG. 1A facial animation transfer method.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides a method, performed on a computer, for transferring facial expressions from a performance input to a three-dimensional (3D) computer graphics (CG) character. The method comprises: providing an inference engine trained for receiving, as input, images exhibiting facial expressions and outputting, for each input image, a 3D CG representation of a CG character having a character facial expression corresponding to the facial expression of the input image; receiving performance input, the performance input comprising, or convertible to, one or more performance input images, each of the one or more performance input images exhibiting a performance facial expression; and inputting the performance input images to the inference engine to thereby infer, for each of the performance input images, a corresponding 3D CG representation of an output CG character having an inferred character facial expression corresponding to the performance facial expression of the performance input image.

Another aspect of the invention provides a method, performed on a computer, for training an inference engine to transfer facial expressions from a performance input to a three-dimensional (3D) computer graphics (CG) character, the performance input comprising, or convertible to, one or more performance input images, each of the one or more performance input images exhibiting a performance facial expression, the inference engine, when trained, capable of inferring, for each performance input image, a corresponding 3D CG representation of an output CG character having an inferred character facial expression corresponding to the performance facial expression of the performance input image, the method comprising: training the inference engine using training input, the training input comprising: source training input comprising, or convertible to, source training images exhibiting facial expressions of one or more source identities; and 3D CG training representations of the output CG character exhibiting facial expressions of the output CG character.

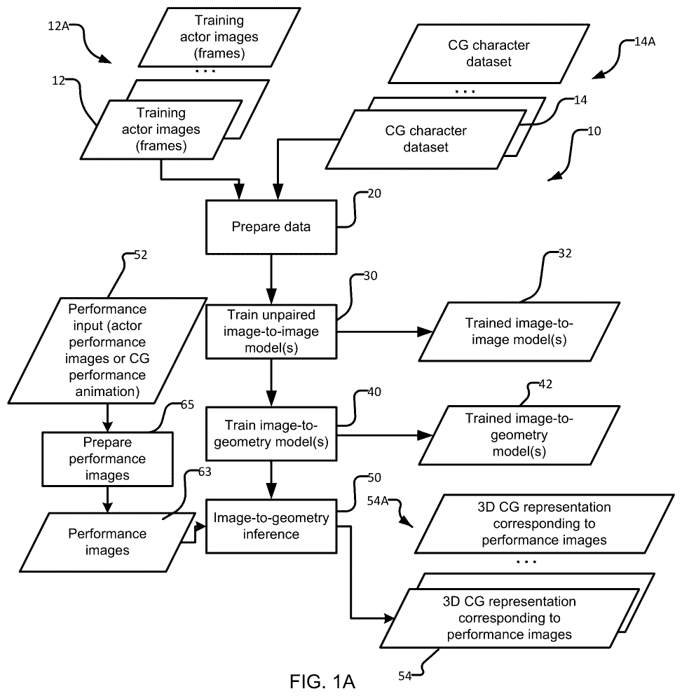

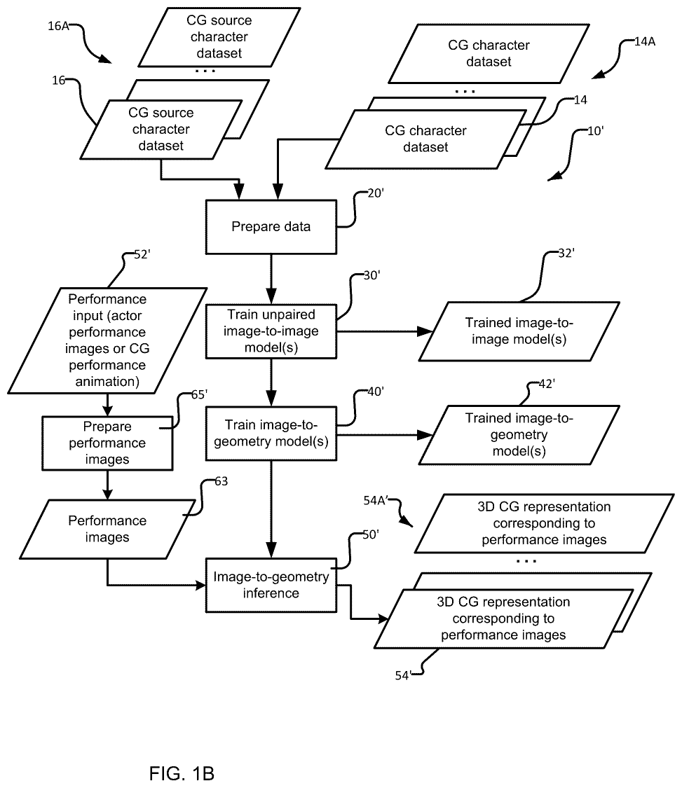

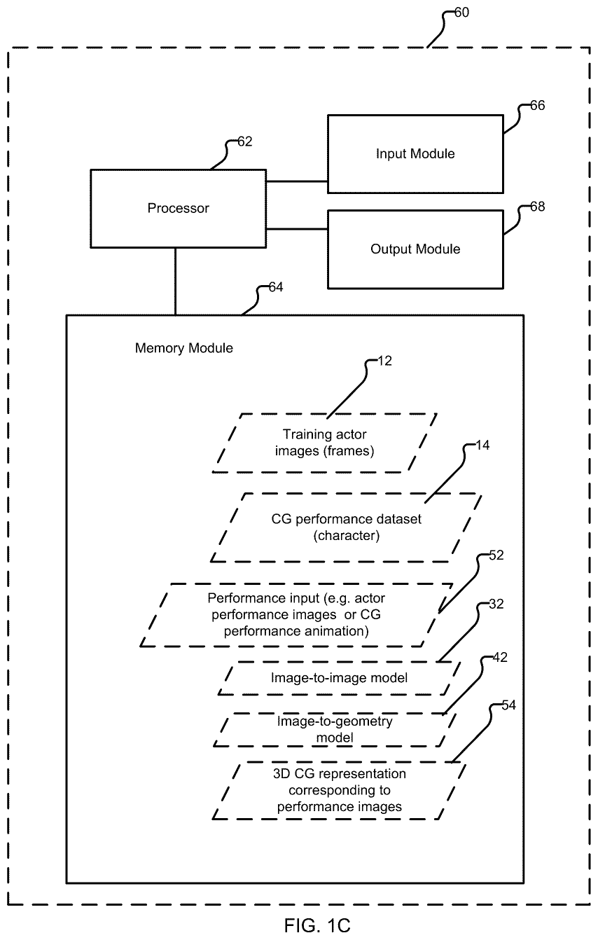

FIG. 1A is a broad schematic depiction of a method 10 for facial animation transfer for facial expressions from one or more actor performances (or CG character performances) to one or more output 3D CG character representations according to a particular embodiment. Method 10 starts with two inputs: one or more sets 12A of actor images 12; and one or more sets 14A of CG character datasets 14. As explained in more detail below, method 10 may generally be performed with any suitable number of sets 12A of actor images 12 and any suitable number (greater than or equal to 1) of sets 14A of CG character datasets 14.

Each set of actor images 12 may comprise a series of video frames of an actor captured using a multiple camera set-up (such as a head-mounted camera (HMC) set-up) although a single camera could be used to capture actor images 12. Actor images 12 may be captured at any suitable frame rate (e.g. at 24 frames per second, 60 frames per second or some other suitable frame capture rate). Actor images 12 may comprise markers.

Each CG character dataset 14 is a computer representation of a CG character comprising a deformable 3D polygonal mesh (inter-connected vertices) of known topology. More specifically, each CG character dataset 14 comprises a plurality of animated samples (shapes, frames or poses) of the 3D polygonal mesh which may be referred to herein as a character 14. Each CG character dataset 14 may comprise animated facial expressions without animated head transforms (commonly referred to as a stabilized CG character dataset 14). In some embodiments, actor images captured by a HMC set-up (including possibly some or all of actor images 12) may be used to generate CG character dataset 14 using known motion capture techniques.

Each CG character dataset 14 may be obtained using any suitable technique. For example, a CG character dataset 14 can be acquired by standard motion capture methods, such as those disclosed, for example, by: Beeler et al. 2011b. High-Quality Passive Facial Performance Capture Using Anchor Frames. ACM Trans. Graph. 30, 4, Article 75 (July 2011), 10 pages; Cong et al. 2019. Local Geometric Indexing of High Resolution Data for Facial Reconstruction from Sparse Markers. CoRR abs/1903.00119 (2019). arXiv:1903.00119; and/or Digital Imaging. 2021. DI4D PRO System. Retrieved May 19, 2011 from https://di4d.com/technology/, all of which are hereby incorporated herein by reference. Advantageously, a CG character dataset 14 obtained using these motion capture methods does not require an underlying animation rig. However, if an animation rig is available, then a CG character dataset 14 can be constructed by manual key-framing of the rig or retargeting animations from other characters to obtain desired data (e.g. range of motion (ROM) poses and/or the like). Method 10 has no requirement for CG character dataset 14 to include temporally continuous samples and even techniques such as randomly sampling an animation rig can be used to build CG character dataset 14.

Method 10 of the illustrated FIG. 1A embodiment shows a method for facial animation transfer of facial expressions from one or more actors (from whom corresponding sets actor images 12 are obtained) or one or more CG character performances to one or more CG characters (from which CG character datasets 14 are obtained). FIG. 1B is a broad schematic depiction of a “character retargeting” method 10′ for facial animation transfer of facial expressions from one or more 3D CG source characters to one or more output 3D CG character representations according to a particular embodiment. In many respects, the FIG. 1B character retargeting method 10′ is the same as, or similar to, the FIG. 1A facial animation transfer method 10. Consequently, analogous aspects of the FIG. 1B character retargeting method 10′ are annotated herein with similar reference numerals to those of the FIG. 1A facial animation transfer method 10, except that the reference numerals of the FIG. 1B character retargeting method 10′ have an apostrophe (′) suffix. This disclosure describes the FIG. 1A facial animation transfer method 10 in detail and focuses on the differences between the FIG. 1B character retargeting method 10′ and the FIG. 1A facial animation transfer method 10, it being understood that other aspects of the FIG. 1B character retargeting method 10′ are the same as, or analogous to, those of the FIG. 1A facial animation transfer method 10.

Character retargeting method 10′ differs from facial animation transfer method 10 in that character retargeting method 10′ receives one or more sets 16A of CG “source” character datasets 16 in the place of one or more sets 12A of actor images 12. CG source datasets 16 may comprise features that are the same as those of CG datasets 14 described above and elsewhere herein. In practice, there is no difference to character retargeting method 10′ between CG source datasets 16 and CG character sets 14. However, this description maintains this distinction for the purposes of drawing analogies to facial animation transfer method 10 of FIG. 1A.

Referring back to FIG. 1A, method 10 involves training a number of neural-network-based models. Consequently, it is currently preferable that each set of actor images 12 and the set of poses (frames) within each CG character dataset 14 have somewhat similar distributions. Such similar distributions can be obtained by asking the actor (from whom each set of actor images 12 is obtained) to perform particular range of motion (ROM) exercises and/or visemes and by generating corresponding ROM poses (frames) within each CG character dataset 14. In an analogous manner, for the FIG. 1B character retargeting method 10′, it is currently preferable that the sets of poses in each CG source character dataset 16 and the sets of poses in each CG character dataset 14 have somewhat similar distributions, which can be obtained by using similar methods of pose generation. By way of non-limiting example, such methods could include: procedural generation of poses from animation rigs and/or choosing sequences with similar animation content (e.g. similar range of motion facial expression content, visemes with similar emotional range content, FACS poses and/or the like).

As explained in more detail below, method 10 also receives performance input 52, which may comprise a set of actor performance images, a CG animation and/or a set of images corresponding to a previously rendered CG animation, and infers (as output) one or more corresponding sets 54A of CG character 3D representations 54 (e.g. one pose/frame of 3D CG character representation 54 for each performance image associated with performance input 52). Performance input 52 may comprise frames of video of an actor, who need not be the same actor that is the source of any of training facial images 12. In some embodiments, performance input 52 may be captured by an HMC (e.g. in cases where actor images 12 used for training are captured by the HMC or otherwise). Performance input 52 may additionally or alternatively comprise a CG character performance animation (which may be generated by applying motion capture techniques to an actor's performance captured with an HMC, with an animation rig or otherwise) from which image frames may be rendered. In such implementations, the CG character associated with performance input 52 need not be the same character that is the source of any of CG character datasets 14 or source CG character datasets used in training. Performance input 52 may additionally or alternatively comprise an already rendered video (e.g. a series of image frames) of a CG character performance. Once again, in such implementations, the CG character associated with performance input 52 need not be the same character that is the source of any of CG character datasets 14 or source CG character datasets used in training. In general, the output of method 10 may comprise one or more sets 54A of CG character 3D representations 54 corresponding to the one or more sets 14A of input CG character datasets 14. While performance input 52′ analogous to performance input 52 may be provided in some embodiments of the FIG. 1B character retargeting method 10′, method 10′ may be particularly effective where performance input 52′ comprises a CG character performance animation (generated with an animation rig or otherwise) from which image frames may be rendered or an already rendered video (e.g. a series of image frames) of a CG character performance, where the CG character in performance input 52′ is one of the CG characters of CG source character datasets 16 or CG character datasets 14 used in training. Character retargeting method 10′ (FIG. 1B) may differ from method 10 (FIG. 1A) in that CG character 3D representations 54′ may correspond to any of the CG characters used in training, including those of CG source character datasets 16 or CG character datasets 14.

Method 10 may receive other optional inputs (not expressly shown) which are well known to those in the field of CG facial animation. Such other inputs may comprise, for example, CG textures, a CG shading component and a definition of a CG camera, which may be used to render a 3D CG geometry, as explained elsewhere herein.

For ease of explanation, method 10 is described for the case of one set of training actor images 12 and one CG character dataset 14. As explained elsewhere herein, method should be understood to include the possibility of a plurality of input sets 12A of actor images 12 and/or a plurality of input sets of 14A CG character datasets 14. Further, for the case of character retargeting method 10′ (FIG. 1B), method 10′ may be modified to use one or more input sets 16A of CG source character data 16 in the place of the one or more input sets 12A of actor images 12.

Method 10 starts in block 20 which involves data preparation. Data preparation in block 20 may comprise processing raw footage of the actor (i.e. actor images 12) and CG character dataset 14 into sets of images that have similar distributions. For character retargeting method 10′ (FIG. 1B), data preparation in block 20′ may comprise processing (e.g. rendering) CG source dataset 16 into sets of images.

Method 10 may then proceed to block 30 which involves unsupervised training of an image-to-image model 32. In some embodiments (e.g. where there is a plurality of CG character datasets 14 and there is a desire for a plurality of output 3D CG representations 54), block 30 may involve training several image-to-image models 32. However, for the sake of brevity, this disclosure describes the training of a single image-to-image model 32, it being understood from this description that a plurality of image-to-image models 32 could be trained in block 30. In an analogous manner, in some embodiments (e.g. where there is a desire for a plurality of output 3D CG representations 54′), block 30′ of the FIG. 1B character retargeting method 10′ may involve training a plurality of image-to-image models 32′.

Image-to-image model 32 (once trained in block 30) can be used to translate between two image domains (e.g. between the domain of images of an actor and the domain of images of a CG character). As will be explained in more detail below, the various poses (frames) of the CG character within CG character dataset 14 can be converted to images and trained image-to-image model 32 may translate an image of actor's face (e.g. within actor images 12 or generally) into a corresponding image of the CG character's face, at a similar head pose and similar facial expression. For character retargeting method 10′ (FIG. 1B), image-to-image training block 30′ comprises converting the poses of CG source character dataset 16 and CG character dataset 14 to images and unsupervised training of an image-to-image model 32′ that translates between the domain of images of CG source character dataset 16 and images of CG character dataset 14.

Method 10 then proceeds to block 40 which involves training an image-to-geometry model 42. In some embodiments (e.g. where there is a plurality of CG character datasets 14 and there is a desire for a plurality of output 3D CG representations 54), block 40 may involve training several image-to-geometry models 42. However, for the sake of brevity, this disclosure describes the training of a single image-to-geometry model 42, it being understood from this description that a plurality of image-to-geometry models 42 could be trained in block 40. In an analogous manner, in some embodiments (e.g. where there is a desire for a plurality of output 3D CG representations 54′), block 40′ of the FIG. 1B character retargeting method 10′ may involve training a plurality of image-to-geometry models 42′.

As explained in more detail below, trained image-to-geometry model 42 may replace image decoders (a portion of image-to-image model 32) with a neural network that maps from encoded representations of images (images of a real actor or images rendered from a CG geometry) to CG animation coefficients (e.g. blendshape weights) for a particular CG character dataset 14 and/or, in the case of character retargeting method 10′ (FIG. 1B) to CG animation coefficients (e.g. blendshape weights) for a particular CG source character dataset 16.

Method 10 then proceeds to block 50 which involves image-to-geometry inference. The block 50 image-to-geometry inference receives performance input 52 which may be suitably prepared in block 65 to generate performance images 63. Performance input 52 may comprise actor performance images, a CG animation to be rendered and/or a previously rendered set of CG images. Block 65 may involve preparing performance images 63 from performance input 52, where performance images 63 are in a format suitable for use by the block 65 image-to-geometry inference process. In some embodiments, the image-preparation procedures of block 65 may be similar to those of block 20. The block 50 image-to-geometry inference uses aspects of image-to-image model 32 and image-to-geometry model 42 to output a 3D CG representation (e.g. blendshape weights) 54 corresponding to performance input 52 (e.g. one frame of 3D CG representation 54 for each rendered or input image of performance input 52). Notably, performance input 52 (from which output 3D CG representation 54 is inferred) may comprise: images from an actor that is not the same as the actor from whom training actor images 12 are obtained; or a CG animation or rendered CG images from a CG character that is not the same as the character from which training CG character dataset 14 is obtained (or from which CG source character dataset 16 is obtained, in the case of character retargeting method 10′).

In some embodiments (e.g. where there is a plurality of CG character datasets 14 and there is a desire for a plurality of output 3D CG representations 54), block 50 may involve inferring a plurality of 3D CG representations 54 (e.g. for different CG characters). However, for the sake of brevity, this disclosure describes the inference of a single 3D CG representation 54, it being understood from this description that a plurality of 3D CG representations 54 (e.g. for different CG characters) could be inferred in block 50. In an analogous manner, in some embodiments (e.g. where there is a desire for a plurality of output 3D CG representations 54′), block 50′ of the FIG. 1B character retargeting method 10′ may involve inferring a plurality of 3D CG representations 54 (e.g. for different CG characters).

In some embodiments, depending on particular applications, the block 30 image-to-image model training and the block 40 image-to-geometry model training could be combined with an objective of training a model that learns the image-to-image and image-to-geometry mappings simultaneously.

Some aspects of the invention provide a system 60 (an example embodiment of which is shown in FIG. 1C) for performing one or more of the methods described herein (e.g. method 10 of FIG. 1A, method 10′ of FIG. 1A or portions thereof). System 60 may comprise a processor 62, a memory module 64, an input module 66, and an output module 68. Memory module 64 may store one or more of the models and/or representations described herein. Processor 62 may receive (via input module 66) one or more sets 12A of training actor images 12 and one or more sets 14A of CG character datasets 14 and may store these inputs in memory module 64. Processor 62 may perform method 10 to train image-to-image model 32 in image-to-image training block 30 and image-to-geometry model 42 in image-to-geometry training block 40 as described herein, and store these models 32, 42 in memory module 64. Processor 62 may receive performance input 52 or precursors to performance input 52 (via input module 66) for example and may store such data in memory module 64. Processor 62 may process this performance input 52 to generate performance images (if required) and may then perform image-to-geometry inference 50 and store 3D CG representation 54 in memory module 64. Processor 62 may render or otherwise output 3D CG representation 54 via output module 68. The components of system 60 may be used to perform method 10′ (FIG. 1B) in an analogous manner.

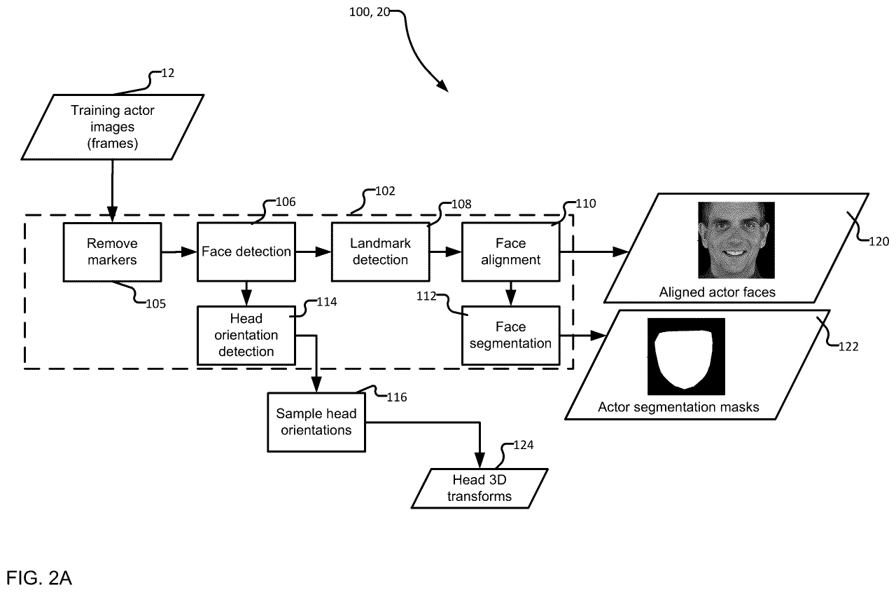

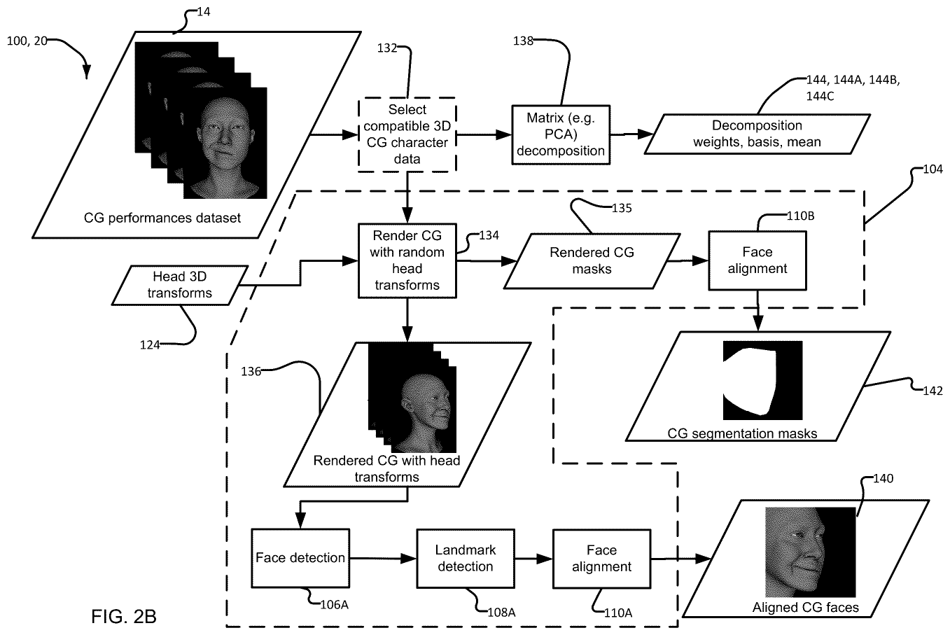

FIG. 2 is a schematic depiction of a method 100 that may be used to implement the block 20 input data preparation for an implementation of the FIG. 1A facial animation transfer method 10 having a single set of actor images 12 and a single CG character dataset 14 according to a particular embodiment. Method 100 may be performed in an automated manner by processor 62 of system 60 (FIG. 1C). Method 100 may be understood to have two branches: a first actor-image branch 102 for processing input actor images 12 (schematically illustrated in FIG. 2A); and a second CG dataset-image branch 104 for processing input CG character dataset 14 (schematically illustrated in FIG. 2B). While, for clarity, method 100 of the FIG. 2 embodiment is shown (and described below) for a single set of actor images 12 and a single CG character dataset 14, it will be appreciated that the procedures of method 100 could be extended to more than one set of actor images 12 (e.g. by repeating the steps of actor-image branch 102 for each image in each set of actor images 12) and/or to more than one CG character dataset 14 (e.g. by repeating the steps of CG-dataset image branch 104 for each pose/frame of each CG character dataset 14).

Actor-image branch 102 (FIG. 2A) starts with input actor images 12 and generates a number of intermediate outputs, comprising aligned actor faces 120 and actor segmentation masks 122. Actor-image branch 102 may be performed once for each frame of input actor images 12 to generate one aligned actor face 120 and one actor segmentation mask 122 for each frame of input actor images 12. In embodiments where actor-images 12 are captured by an HMC, actor-image branch 102 may be performed for the images captured by both cameras (e.g. actor-image branch 102 may generate one aligned actor face 120 and one actor segmentation mask 122 for each image capture by each camera).

For each frame of input actor images 12, actor-image branch 102 starts in optional block 105 which comprises removing markers from the actor's face in the current frame, in cases where such markers are present (e.g. when input actor images 12 come from a HMC motion capture setup). One suitable non-limiting example technique to remove markers from images of a face of an actor is described in PCT/CA2022/050360 entitled METHODS AND SYSTEMS FOR MARKERLESS FACIAL MOTION CAPTURE, which is hereby incorporated by reference for all purposes.

Actor-image branch 102 then proceeds to block 106 which comprises performing a face detection operation to determine a bounding box in the current frame which includes the actor's face. There are numerous face detection techniques known in the art that may be used in block 106. One suitable non-limiting technique, is that disclosed by Bulat et al. 2017. How far are we from solving the 2D & 3D Face Alignment problem? (and a dataset of 230,000 3D facial landmarks). In International Conference on Computer Vision., which is hereby incorporated herein by reference.

Actor-image branch 102 then proceeds to block 108 which involves applying a 2D landmark detection process within the bounding box determined in block 106 to find fiducial points on the face. There are numerous facial landmark detection techniques known in the art that may be used in block 108. One suitable non-limiting technique, is that disclosed by Bulat et al. cited above. In some embodiments, the 2D landmarks (fiducial points) of interest in block 108 include landmarks from the eyebrows, eyes and/or nose.

Using the 2D landmarks detected in block 108 actor-image branch 102 then proceeds to block 110 which involves computing and applying a 2D affine transformation that will align the block 108 2D landmarks to canonical (e.g. front-facing head pose) 2D landmarks such that the 2D landmarks (e.g. eyes, nose, mouth and/or the like) are stabilized across frames of actor images 12. Suitable non-limiting techniques for this block 110 process are described in: Shinji Umeyama. 1991. Least-Squares Estimation of Transformation Parameters Between Two Point Patterns. IEEE Trans. Pattern Anal. Mach. Intell. 13, 4 (1991), 376-380; and Naruniec et al. cited above; both of which are hereby incorporated herein by reference. The output of the block 110 process is a cropped canonical front head pose (referred to herein as aligned actor face 120) corresponding to the current frame of training actor images 12. In some embodiments block 110 may compute 2D affine transformations that will align the actor's face to a canonical front head pose for a first (e.g. suitably selected) reference frame and apply the 2D affine transformations to one or more other frames.

The block 108 detected landmarks and the block 110 aligned face coordinates may be used in block 112 to build an actor face segmentation mask 122 corresponding to the current frame of training actor images 12. One suitable non-limiting technique for performing this block 112 face segmentation process to generate actor face segmentation masks 122 is described in Naruniec et al. cited above. There are other techniques known to those skilled in the art for generating facial actor segmentation masks 122, some of which do not rely on detected landmarks. Some such techniques include, without limitation, training machine learning models to predict labels per pixel for generation of semantic face segmentation masks on labelled regions of the face as described, for example, by Chen et al. (2017). Rethinking Atrous Convolution for Semantic Image Segmentation. arXiv:1706.05587 [cs.CV], which is hereby incorporated herein by reference.

Actor-image branch 102 of the illustrated FIG. 2A embodiment also comprises block 114, which uses the detected faces from block 106 and estimates the actor's head orientation in the current frame of training actor images 12. One suitable non-limiting technique for performing this block 114 head pose detection process is disclosed in Ruiz et al. 2018. Fine-Grained Head Pose Estimation Without Keypoints. In The IEEE Conference on Computer Vision and Pattern Recognition (CVPR) Workshops., which is hereby incorporated herein by reference.

Once head orientations are obtained in block 114 for all (or some suitable subset) of training actor images 12, block 116 (which is not strictly part of actor-image branch 102 or CG dataset-image branch 104) may involve sampling (e.g. randomly) a plurality of the head orientations detected in the various (per frame) iterations of block 114 to obtain a set of 3D head transforms 124 which may be used in CG dataset-image branch 104 to render 2D images of the CG input data with various (e.g. random) head orientations as described in more detail below. In some embodiments, block 116 may additionally involve introducing a small (e.g. less than a pre-set or user configurable threshold—e.g. 5°, 10° or the like) random rotation to the head orientations detected in block 114 to account for potential errors in the block 114 head orientation estimation.

Turning now to CG dataset-image branch 104 (FIG. 2B), CG dataset-image branch 104 involves processing (preparing) input CG character dataset 14 to yield a number of intermediate outputs, comprising aligned CG faces 140 (analogous to aligned actor faces 120) and CG segmentation masks 142 (analogous to actor segmentation masks 122). CG dataset-image branch 104 may be performed once for each pose (frame) of CG character dataset 14 to generate one or more aligned CG faces 140 and one or more CG segmentation mask 142.

Before starting with the per-frame iterations of CG dataset-image branch 104, method 100 may involve the optional step of selecting, generating or otherwise obtaining 3D CG character data that is compatible with actor images 12. In some embodiments, the block 132 selection of 3D CG character data may comprise selecting a subset of CG character dataset 14 or generating (e.g. using a rig, by key-framing or otherwise generating) a set of CG character data that is compatible with actor images 12. In some instances, block 132 is not required, because CG character dataset 14 already includes suitable performances (such as, for example, range-of-motion (ROM), exercising poses from Facial Action Coding System (FACS), visemes with different emotional expressions and/or the like) and method (FIG. 1A) may involve obtaining an actor performance (actor images 12) that are compatible with CG character dataset 14. For brevity and without loss of generality, the block 132 selected poses (frames) of CG character dataset 14 may be referred to hereinafter as CG character dataset 14 and references to CG character dataset 14 should be understood to include the possibility of the block 132 selected poses (frames) of CG character dataset 14 unless the context dictates otherwise.

CG dataset-image branch 104 starts in block 134 which involves, for each pose (frame) of CG character dataset 14, rendering one or both of a plurality of CG-based images 136 and a plurality of CG-based masks 135 using a number of the randomly sampled head transforms 124 discussed above. Advantageously, using head transforms 124 generated from actor images 12 permits the block 134 rendering process to generate CG based images 136 and/or CG-based masks 135 that match (to some degree) the data distribution of head orientations in actor images 12. The number of CG-based images 136 and/or CG-based masks 135 rendered in block 134 for each pose (frame) of CG character dataset 14 is a parameter of method 100 that may be pre-set or user-configurable. In some embodiments, this parameter is in a range of 1-5 CG-based images 136 and/or CG-based masks 135 rendered in block 134 for each pose (frame) of CG character dataset 14, with each CG-based image 136 having a different random head orientation. In embodiments where block 134 renders both a plurality of CG-based images 136 and CG-based masks 135, each CG-based image 136 may have a corresponding CG-based mask 135.

In some embodiments, other additional or alternative augmentations of CG character dataset 14 may be applied prior to or while rendering these poses (frames) in block 134. In some embodiments, source data for these additional or alternative augmentations may be randomly sampled from among actor images 12 in a manner analogous to head pose detection and sampling in blocks 114, 116 to generate head pose transforms 124 in the illustrated embodiment (see FIG. 2A), although this is not necessary. In some embodiments, these additional or alternative augmentations may be randomly applied. By way of non-limiting example, such additional or alternative augmentations could include eye transformations, variations in lighting, variations in background (color, luminosity and/or the like), occlusions, lens distortions, field of view augmentations and/or the like.

Any suitable rendering process may be used in block 134. In some embodiments, the block 134 process to render CG-based images 136 involves the use of a single point light that coincides with the camera origin, and a Lambertian shader effectively reproducing facing-ratio shading. Additionally or alternatively the block 134 process to render CG-based images 136 may involve using various textures in the face. Textures may include the original actor's facial texture with skin details or more generic textures that associate different colours with facial regions, in other words each region is associated with a colour, (e.g. a first colour with the lips, a second colour with the nose, a third colour with the eyes, etc.). Rendering involving textures may in some ways resemble segmentation models. In some embodiments, additional or alternative augmentation of CG character dataset 14 (such as randomly varying the point-light position) may be performed as part of the block 134 process to render CG-based images 136.

In some embodiments the block 134 process to render CG-based masks 135 involves the use of a shader to distinguish facial regions from non-facial regions. For example, the shader may set facial regions to a first binary number (e.g. 1) and other regions to the other binary number (e.g. 0). Set binary numbers may have further associated actions. For example, regions associated with the first binary number (e.g. facial regions) may be shaded a first colour (e.g. white). Additionally or alternatively regions associated with the other binary number (e.g. non facial regions) may be shaded a second colour (e.g. black). In some embodiments, additional or alternative augmentation of CG character dataset 14 may be performed as part of the block 134 process to render CG-based masks 135.

CG-based images 136 are 2D images. Once CG-based images 136 are obtained in block 134, each of CG-based images 136 is aligned, cropped and used to generate aligned CG faces 140 in blocks 106A, 108A, 110A which are analogous to, and involve analogous steps to, blocks 106, 108, 110, described above in connection with actor-image branch 102. CG-based masks 135 are aligned in block 110B which is analogous to, and involves analogous steps to block 110 described above in connection with actor-image branch 102, to produce CG segmentation masks 142. In some embodiments, block 110B may involve analogous steps to block 110A described above in connection with CG-based images 136. In some embodiments, block 110B may apply to CG-based masks 135 the same affine transformations computed in block 110A for CG-based images 136. It will be appreciated that blocks 106A, 108A, 110A, 110B are performed once for each CG-based image 136 and/or CG-based mask 135 for each of the poses (frames of CG character dataset 14). In some embodiments, aligned CG faces 140 and/or CG segmentation masks 142 may be saved to a datastore. In some embodiments at least one aligned CG face 140 and/or at least one CG segmentation mask 142 may be reused in subsequent iterations of facial animation transfer method 10 and/or data preparation method 100.

For the purposes of character retargeting method 10′ (FIG. 1B), the procedures of the block 20′ data preparation process may differ from those of method 100 (FIG. 2) in the sense that actor-image branch 102 may be replaced with a CG source character image branch which may prepare aligned CG source face images from CG source character dataset 16 in a manner similar to how CG-dataset image branch 104 prepares aligned CG faces 140 from CG character dataset 14. Further, in the block 20′ data preparation process, blocks 114, 116 are not required. The block 134 rendering for the CG source character image branch and for the CG-dataset image branch 104 may be performed with a fixed head transform (facing the camera) for all of the block 132 CG poses (frames) extracted from CG source character dataset 16 or from CG character dataset 14, as the case may be.

Method 100 also comprises block 138 (FIG. 2B) which involves computing a matrix decomposition for the poses (frames) of CG character dataset 14. In one particular embodiment, block 138 uses a principal component analysis (PCA) blendshape decomposition which retains some suitable percentage (e.g. a pre-set or user-configurable percentage which may be greater than 98%) of the variance of the poses (frames) of CG character dataset 14. It will be understood that the block 138 blendshape decomposition (which is described herein as being a PCA decomposition) could, in general, comprise any suitable form of matrix decomposition technique or dimensionality reduction technique (e.g. independent component analysis (ICA), non-negative matrix factorization (NMF), FACS-based matrix decomposition and/or the like) or other geometry compression technique (e.g. deep learning based geometry compression techniques). For brevity, block 138, its output matrix decomposition 144 (including its weights 144A, basis matrix 144B and mean vector 144C) are described herein as being a PCA decomposition (e.g. PCA decomposition 144, PCA weights 144A, PCA basis matrix 144B and PCA mean vector 144C). However, unless the context dictates otherwise, these elements should be understood to incorporate the process and outputs of other forms of matrix decomposition, dimensionality reduction techniques and/or geometry compression techniques.

As discussed above, CG character dataset 14 is a 3D mesh of vertices over a plurality of poses/frames (i.e. a plurality of different sets of 3D vertex positions). For example, CG character dataset 14 may comprise a series of poses/frames (e.g. f poses/frames), where each pose/frame comprises 3D (e.g. {x, y, z}) position information for a set of n vertices. Accordingly, CG character dataset 14 may be represented in the form of a matrix X (input CG dataset matrix X) of dimensionality [f, 3n]. As is known in the art of PCA matrix decomposition, block 138 PCA decomposition may output a PCA mean vector \vec{μ}, a PCA basis matrix V and a PCA weight matrix Z, which, together, provide PCA decomposition 144.

PCA mean vector may comprise a vector of dimensionality 3n, where n is the number of vertices in the topology of CG character dataset 14. Each element of PCA mean vector may comprise the mean of a corresponding column of input CG dataset matrix X over the f poses/frames. PCA basis matrix V may comprise a matrix of dimensionality [k, 3n], where k is a number of blendshapes (also referred to as eigenvectors) used in the block 138 PCA decomposition, where k<min(f, 3n). The parameter k may be a preconfigured and/or user-configurable parameter. The parameter k may be configurable by selecting the number k outright, by selecting a percentage of the variance in input CG dataset matrix X that should be explained by the k blendshapes and/or the like. In some currently preferred embodiments, the parameter k is determined by ascertaining a blendshape decomposition that has the variance to retain 99.9% of the input CG dataset matrix. Each of the k rows of PCA basis matrix V has 3n elements and may be referred to as a blendshape. PCA weights matrix Z may comprise a matrix of dimensionality [f, k]. Each row the matrix Z of PCA weights 23 is a set (vector) of k weights corresponding to a particular pose/frame of input CG dataset matrix X.

The poses/frames of input CG dataset matrix X can be approximately reconstructed from the PCA decomposition according to \hat{X}=ZV+\vec{Ψ}, where \hat{X} is a matrix of dimensionality [f, 3n] in which each row of \hat{X} represents an approximate reconstruction of one pose/frame of input CG dataset matrix X and \vec{Ψ} is a matrix of dimensionality [f, 3n], where each row of \vec{Ψ} is the PCA mean vector \vec{μ}. An individual pose/frame of input CG dataset matrix X can be approximately constructed according to \hat{x}=\vec{z}V+\vec{μ}, where \hat{x} is the reconstructed pose/frame comprising a vector of dimension 3n, \vec{z} is the set (vector) of weights having dimension k selected as a row of PCA weight matrix Z. In this manner, a vector \vec{z} of weights (also referred to as blendshape weights) may be understood (together with the PCA basis matrix V and the PCA mean vector \vec{μ}) to represent a pose/frame of a 3D CG mesh.

For the purposes of character retargeting method 10′ (FIG. 1B), the procedures of the block 20′ data preparation process may optionally involve computing a matrix decomposition, dimensionality reduction and/or geometry compression for the poses (frames) of CG source character dataset 16, although this is not necessary.

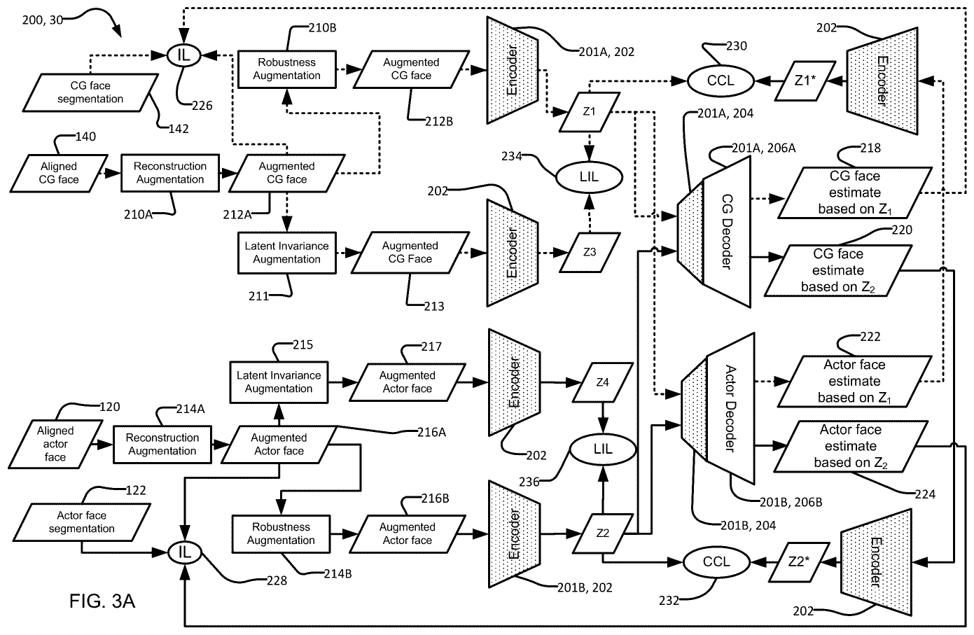

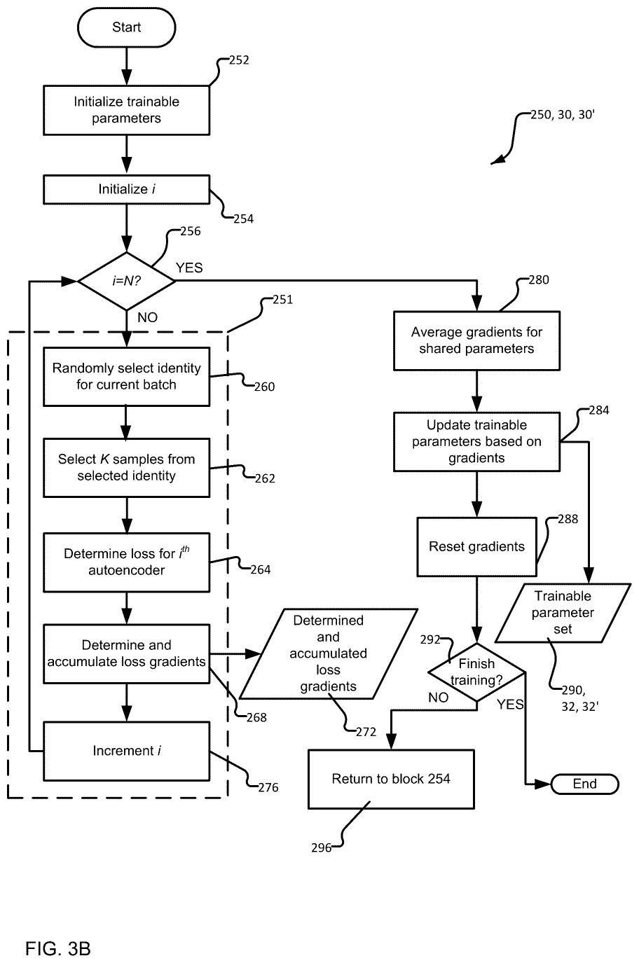

FIG. 3A is a schematic depiction of a training scheme 200 illustrating the computation of criterion functions (IL, LIL and CCL criterion functions in the case of the illustrated embodiment) that may be used to implement the block 30 training of image-to-image model 32 for the FIG. 1A facial animation transfer method 10 having a single set of input actor images 12 and a single CG character dataset 14 according to a particular embodiment. The block 30 training of image-to-image model 32 may be performed by processor 62 of system 60 (FIG. 1C) using training scheme 200. Training scheme 200 uses unsupervised training—that is, there is no a priori pairing of aligned CG faces 140 and aligned actor faces 120—and training scheme 200 trains autoencoders 201 (described in more detail below) to reconstruct corresponding CG character images from actor images (e.g. the same facial expressions and head poses) and vice-versa using image loss (IL) criterion functions within the same domain (e.g. IL criterion functions 226, 288 described in more detail below); training scheme 200 also trains autoencoders 201 to share the same representations between CG character image and actor image domains using latent-cycle consistency loss (CCL) criterion functions (e.g. CCL criterion functions 230, 232 described in more detail below); and training scheme 200 may also optionally train autoencoders 201 to reduce the variability of the representation of latent factors using optional latent invariance loss (LIL) criterion functions (e.g. LIL criterion functions 234, 236 described in more detail below). After training, any image (CG image or actor image) can be used as input and the trained autoencoders 201 of training scheme 200 can reconstruct any output image (CG image or actor image) in the same expression and head pose.

Image-to-image model training scheme 200 receives, as input, the data output from the method 100 (block 20) data preparation. Specifically, image-to-image model training scheme 200 receives aligned actor faces 120, corresponding actor segmentation masks 122, aligned CG faces 140, and corresponding CG segmentation masks 142. Image-to-image model training scheme 200 involves training autoencoders for both the CG domain (autoencoder 201A) and the actor domain (autoencoder 201B), collectively, autoencoders 201. Autoencoders 201 are a type of neural network suitable for unsupervised learning which comprise an encoder that compresses their input into a latent code and a decoder that decompresses the latent code to reconstruct the original input. Autoencoders 201 depicted in the illustrated embodiment of the FIG. 3A training scheme 200 are constructed such that their encoders 202 and one or more initial layers 204 of their decoders 206A, 206B (collectively, decoders 206) share the same weights or trainable parameters (i.e. are the same). This identity of encoders 202 and the one or more initial layers 204 of decoders 206A, 206B is shown schematically in FIG. 3A by shading. Apart from its one or more initial layers 204, decoder 206A is unique to the character of CG character dataset 14 (FIG. 1) and, as described in more detail below, decoder 206A is trained to reconstruct CG face estimates of the CG character dataset 14. Similarly, apart from its one or more initial layers 204, decoder 206B is unique to the actor of actor images 12 (FIG. 1) and, as described in more detail below, decoder 206A is trained to reconstruct actor face estimates of the actor in actor images 12. Image-to-image model 32 (FIG. 1) may comprise autoencoders 201A, 201B (e.g. the combination of encoder 202 and decoders 206, including the shared one or more initial layers 204 of decoders 206).

Table 1 shows the architecture of the shared encoder 202 according to a particular example embodiment, where convolutions use a stride of 2 and zero padding of 1 and the network comprises Leaky ReLU activations with a slope of 0.1.

TABLE 1
Encoder Architecture

| Name | Layer | Activation | Output Shape | Parameters |
|---|---|---|---|---|
| input | | | 3 × 128 × 128 | |
| | Conv3 × 3 | LeakyReLU | 32 × 64 × 64 | 2,432 |
| | Conv3 × 3 | LeakyReLU | 64 × 32 × 32 | 5,1264 |
| | Conv3 × 3 | LeakyReLU | 128 × 16 × 16 | 204,928 |
| | Conv3 × 3 | LeakyReLU | 256 × 88 × 8 | 819,456 |
| | Flatten | | 16384 | |
| bottleneck | Dense | | 512 | 41,943,552 |
| | | | | 43,021,632 |

Table 2 shows the architecture of the decoder 206 according to a particular example embodiment. Layers marked with an asterisk are shared across all decoder instances. Leaky ReLU activations use a slope of 0.1 unless otherwise stated in parentheses. PixelShuffle layers upsample by a factor of 2. Pairs of consecutive convolutions are composed as residual blocks.

TABLE 2
Decoder architecture

| Name | Layer | Activation | Output shape | Parameters |
|---|---|---|---|---|
| input | | | 16384 | |
| f_out | *Dense | — | 32768 | 16,809,984 |
| | *Reshape | — | 512 × 8 × 8 | |
| | *Conv3 × 3 | LeakyReLU | 2048 × 8 × 8 | 9,439,232 |
| | *Pixel- | — | 512 × 16 × 16 | |
| | Shuffle | | | |
| image_in | Conv3 × 3 | LeakyReLU | 2016 × 16 × 16 | 9,291,744 |
| | Pixel- | — | 504 × 32 × 32 | |
| | Shuffle | | | |
| | Conv3 × 3 | LeakyReLU | 504 × 32 × 32 | 2,286,648 |
| | | (0.2) | | |
| | Conv3 × 3 | LeakyReLU | 504 × 32 × 32 | 2,286,648 |
| | | (0.2) | | |
| | Conv3 × 3 | LeakyReLU | 1008 × 16 × 16 | 4,573,296 |
| | Pixel- | — | 252 × 64 × 64 | |
| | Shuffle | | | |
| | Conv3 × 3 | LeakyReLU | 252 × 64 × 64 | 571,788 |
| | | (0.2) | | |
| | Conv3 × 3 | LeakyReLU | 252 × 64 × 64 | 571,788 |
| | | (0.2) | | |
| | Conv3 × 3 | LeakyReLU | 504 × 64 × 64 | 1,143,576 |
| | Pixel- | — | 126 × 128 × 128 | |
| | Shuffle | | | |
| | Conv3 × 3 | LeakyReLU | 126 × 128 × 128 | 143,010 |
| | | (0.2) | | |
| | Conv3 × 3 | LeakyReLU | 126 × 128 × 128 | 143,010 |
| | | (0.2) | | |
| image_{—} | Conv1 × 1 | Sigmoid | 3 × 128 × 128 | 381 |
| out | | | | |
| | | | | 47,261,105 |

Aligned CG faces 140 are randomly augmented in reconstruction augmentation block 210A using affine transformations to generate augmented CG faces 212A. Aligned actor faces 120 are similarly randomly augmented using affine transformations in reconstruction augmentation block 214A to generate augmented actor faces 216A. The affine transformations applied in blocks 210A, 214A may comprise random translation (e.g. less than a maximum of 5%, 10% some other configurable threshold of image size), rotation (e.g. less than a maximum 5°, 10° or some other configurable threshold of rotation) and/or uniform scale (e.g. less than 5%, 10% some other configurable threshold in scale). The outputs of the block 210A, 214A affine transformations are augmented CG faces 212A and augmented actor faces 216A which, in the illustrated embodiment, are used to determine IL loss evaluations 226, 228.

Augmented CG faces 212A and augmented actor faces 216A may be further augmented in robustness augmentation blocks 210B, 214B to provide augmented CG faces 212B and augmented actor faces 216B respectively. Robustness augmentation blocks 210B, 214B may augment augmented CG faces 212A, augmented actor faces 216A in any desired manner, for which it is desirable for autoencoders 201 (once trained) to be robust against. That is robustness augmentation blocks 201B, 214B may be used to train autoencoders 201 using any suitable augmentations, so that trained autoencoders 201 are invariant to (i.e. robust against) such augmentations. In some embodiments, the augmentation in robustness augmentation blocks 210B, 214B may comprise warping. Warping for example may comprise grid distortion wherein the input images are distorted by 2D warp vectors defined for each pixel. The warp vectors may be computed by first creating a grid of coordinates with random number of columns/rows (2, 4, 8 or 16), followed by random shifts on the cell coordinates (24% of the cell size) and lastly, up-sampling the grid to match the image resolution. These image augmentations are described, for example, in Buslaev A. et al. Albumentations: Fast and Flexible Image Augmentations. Information. 2020; 11(2):125., which is hereby incorporated herein by reference.

Image estimates 218, 220, 222, 224 produced by decoders 206 (discussed in more detail below) may include the augmentations of reconstruction augmentation blocks 210A, 214A. Image estimates 218, 220, 222, 224 produced by decoders 206 may exclude the augmentations of robustness augmentation blocks 210B, 214B. In other words, encoders 202 and decoders 206 may be taught such that decoders 206 reproduce augmented CG faces 212A and augmented actor faces 216A.

One or more of reconstruction augmentation blocks 210A, 214A and robustness augmentation blocks 210B, 214B may apply one or more of the following:
(i) Color transfer augmentations (e.g. linear color transfer, reinhard color mapping, etc.);
(ii) Background variation augmentations (e.g. replacing non-face pixels in aligned CG faces 140 and/or aligned actor faces 120 using random rectilinear crops from several indoor panoramic high dynamic range images (HDRI), at multiple exposures, using a 3D mesh and/or CG segmentation masks 142, actor segmentations masks 122);
(iii) Light augmentations (e.g. brightness variations, 2D spot lights, gradients, etc.);
(iv) 3D light augmentations (e.g. to account for face shape, to simulate random objects placed in front of the face, etc. (e.g. by using standard motion capture technology to extract the normal and using the normal to introduce light variations in the aligned CG faces 140 and/or aligned actor faces 120));
(v) Augmentations that account for camera position (e.g. rendering the 3D reconstructed facial geometry with its projected textures from one or more HMC images, using different camera positions);
(vi) Augmentations that account for noise (e.g. removing salt and pepper, speckles, etc.);
(vii) Augmentations that account for lens distortion;
(viii) Augmentations that account for random occlusions and/or cutouts;
(ix) Augmentations that account for blurriness or sharpness;
(x) Mask augmentations (e.g. to replicate the variations seen in the HMC domain (e.g. by using erosion, dilation, blur, noise across the edge augmentations, and/or the like)).

In some embodiments, other types of additional or alternative image augmentations, such as grid distortions, elastic transforms and piecewise affine transformations could be used in blocks 210A, 210B and/or blocks 214A, 214B. While not expressly an image augmentation, the last step of the image augmentation in blocks 210A, 210B, 214A, 214B may be to scale the input resolution to match the expected resolution for the neural network configuration. In some non-limiting embodiments, images are scaled to 128×128 pixels, which may correspond to the resolution that autoencoders 201 are designed for. In some embodiments, autoencoders 201 may be designed for other resolutions and this scaling process may scale the images to other resolutions.

Augmented CG faces 212B and augmented actor faces 216B (or augmented CG faces 212A and augmented actor faces 216A in the case where robustness augmentation in blocks 210B, 214B is not used) are fed to encoders 202. For brevity, augmented CG faces 212A, 212B (collectively, augmented CG faces 212) and augmented actor faces 216A, 216B (collectively, augmented actor faces 216) may be referred to herein as CG faces 212 and actor faces 216.

Encoders 202 respectively generate, a latent code Z1 for each CG face 212 and a latent code Z2 for each actor face 216. Latent codes Z1, Z2 are then fed to both decoders 206A, 206B. As alluded to above, decoder 206A (which may be referred to herein as CG decoder 206A) attempts to (and is trained to) reconstruct CG face estimates based on the input latent codes Z1, Z2. Specifically, CG decoder 206A attempts to (and is trained to) reconstruct a CG face estimate 218 based on the latent code Z1 corresponding to each aligned CG face 140 and CG decoder 206A may attempt to reconstruct a CG face estimate 220 based on the latent code Z2 corresponding to each aligned actor face 120. In an analogous manner, decoder 206B (which may be referred to herein as actor decoder 206B) attempts to (and is trained to) reconstruct actor face estimates based on the input latent codes Z1, Z2. Specifically, actor decoder 206B attempts to (and is trained to) reconstruct an actor face estimate 222 based on the latent code Z1 corresponding to each aligned CG face 140 and actor decoder 206B may attempt to reconstruct an actor face estimate 224 based on the latent code Z2 corresponding to each aligned actor face 120.

Image-to-image model training scheme 200 may optionally additionally apply latent invariance augmentation to CG faces 212A and actor faces 216A in latent invariance augmentation blocks 211 and 215. Latent invariance augmentation blocks 211, 215 produce latently augmented CG faces 213, latently augmented actor faces 217 by editing factors of variation in augmented CG faces 212A and/or augmented actor faces 216A. A factor of variation may correspond to an image attribute that is consistently present in a set of images (i.e. augmented CG faces 212A or augmented actor faces 216A). Examples of factors of variation include, specific poses, colours of objects, backgrounds, lighting in images, etc. For example, latent invariance augmentation blocks 211, 215 may change the colour (e.g. black out) of background pixels (e.g. pixels that do not belong to a CG face, actor face), change the lighting of the scene (e.g. make the lighting darker, lighter, change the light direction, etc.), and/or change the occlusion. Latent invariance augmentation blocks 211, 215 may scale the resolution of latently augmented CG faces 213 and/or latently augmented actor faces 217 to correspond to the resolution for which autoencoders 201 are designed in a manner similar to that discussed above for robustness augmentation blocks 210B, 214B. Latently augmented CG faces 213 and latently augmented actor faces 217 are fed to encoders 202. Encoders 202 generate, a latent code Z3 for each latently augmented CG face 213 and a latent code Z4 for each latently augmented actor face 217.

Image-to-image model training scheme 200 according to the FIG. 3A embodiment involves the use of a number of loss functions (also known as objective functions) which are minimized during the image-to-image training process to determine the weights for encoder 202 and decoders 206A, 206B and to thereby generate a trained image-to-image model 32. Image-to-image model training scheme 200 has three types of loss functions: image loss (IL) functions, which compare reconstructed images that come from the same source data (e.g. images reconstructed from encoded CG faces are compared to CG faces and images reconstructed from encoded actor faces are compared to actor faces); latent-cycle consistency loss (CCL) functions, which compare latent codes Z1*, Z2* encoded from reconstructed images that come from different source data (e.g. latent codes Z2* encoded from images 220 reconstructed from encoded CG faces 212 are compared to latent codes Z2 encoded from actor faces 216 and latent codes Z1* encoded from images 222 reconstructed from encoded actor faces 216 are compared to latent codes Z1 encoded from CG faces 212); and latent invariance loss (LIL) functions, which compare latent codes encoded from images with varying augmentation (e.g. latent codes Z3, Z4 encoded from latently augmented CG faces 213 and latently augmented CG faces 217 are compared to latent codes Z1 and Z2 which are encoded from CG faces 212 and actor faces 216).

In the specific case of the FIG. 3A embodiment 200, there are two evaluations of the IL function (which may be for two consecutive training batches (see discussion of FIG. 3B below) covering aligned actor faces 120 and aligned CG faces 140): IL function evaluation 226 which, using CG face segmentation mask 142 corresponding to each aligned CG face 140, ascertains loss (differences) between each input affine-augmented CG face 212A and CG face estimate 218 (which is reconstructed by decoder 206A based on the latent code Z1 that is generated by encoder 202 in connection with the input aligned CG face 140); and IL function evaluation 228 which, using actor face segmentation mask 122 corresponding to each aligned actor face 120, ascertains loss (differences) between each input affine-augmented actor face 216A and actor face estimate 224 (which is reconstructed by decoder 206B based on the latent code Z2 that is generated by encoder 202 in connection with the input aligned actor face 120). In general, the IL function that is used for IL function evaluations 226, 228 may comprise a number of terms that are representative of differences between their respective input images and reconstructed images. In one particular embodiment, the IL function that is used for IL function evaluations 226, 228 comprise least absolute deviation (L1 norm) and structural similarity index measure (SSIM) criterion functions. Other additional or alternative criterion functions could be included in the IL function used for IL function evaluations 226, 228.

In the specific case of the FIG. 3A embodiment 200, there are two CCL function evaluations (which may be for two consecutive training batches (see discussion of FIG. 3B below) covering latent codes corresponding to aligned actor faces 120 and aligned CG faces 140): CCL function evaluation 230 and CCL function evaluation 232. In the illustrated FIG. 3A embodiment, CCL function evaluations 230, 232 ascertain losses (differences) between latent codes. More specifically:
(i) CCL function evaluation 230 ascertains loss (differences) between:
   (a) latent code Z1 generated (by encoder 202 of autoencoder 201A) from an input aligned CG face 140 (specifically, an augmented CG face 212B); and
   (b) a latent code Z1* generated by encoder 202 from reconstructed actor face 222, that is in turn generated by actor decoder 206B based on latent code Z2 generated (by encoder 202 of autoencoder 201B) from an input aligned actor face 120 (specifically, an augmented actor face 216B); and
(ii) CCL function evaluation 232 ascertains loss (differences) between:
   (a) latent code Z2 generated (by encoder 202 of autoencoder 201B) from an input aligned actor face 120 (specifically, an augmented actor face 216B); and
   (b) a latent code Z2* generated by encoder 202 from reconstructed CG face 220, that is in turn generated by CG decoder 206A based on latent code Z1 generated (by encoder 202 of autoencoder 201A) from an input aligned CG face 140 (specifically, an augmented CG face 212B).
      In some embodiments, CCL loss function evaluations 230, 232 are only used for back-propagation (computing gradients) for encoder 202 and the one or more initial layers 204 of decoders 206. In this manner, the CCL functions that are the subject of CCL loss function evaluations 230, 232 (when minimized) encourage encoder 222 and the one or more initial layers 204 of decoders 206A, 206B to map the latent codes (Z1*, Z2*) corresponding to decoded images 222, 220 from the “opposite” decoder 206B, 206A to match latent codes Z1, Z2 from the input CG and actor images 140, 120. In some embodiments, CCL loss function evaluations 230, 232 may also be used for back propagation (computing gradients) for the non-shared layers of decoders 206. In general, the CCL loss function that is used for CCL loss function evaluations 230, 232 may comprise a number of terms that are representative of differences between their respective latent codes. In one particular embodiment, the CCL function that is used for CCL loss function evaluations 230, 232 comprise mean square error (MSE) and/or least square error (L2 norm) criterion functions. Other additional or alternative criterion functions could be included in the CCL function that is used for CCL loss function evaluations 230, 232.

In the specific case of the FIG. 3A embodiment 200, there are two LIL function evaluations (which may be for two consecutive training batches (see discussion of FIG. 3B below) covering latent codes corresponding to aligned actor faces 120 and aligned CG faces 140): LIL function evaluation 234 and LIL function evaluation 236. In the illustrated FIG. 3A embodiment, LIL function evaluations 234, 236 ascertain losses (differences between latent codes. More specifically:
(i) LIL function evaluation 234 ascertains loss (differences) between:
   (a) Latent code Z1 (generated by encoder 202 of autoencoder 201A) from an augmented CG face 212B; and
   (b) Latent code Z3 (generated by encoder 202) from latently augmented CG face 213; and
(ii) LIL function evaluation 236 ascertains loss (differences) between:
   (a) Latent code Z2 (generated by encoder 202 of autoencoder 201B) from an augmented actor face 216B; and
   (b) Latent code Z4 (generated by encoder 202) from latently augmented actor face 217.
      In some embodiments, LIL loss function evaluations 234, 236 are only used for back-propagation (computing gradients) for encoder 202 and the one or more initial layers 204 of decoders 206. In this manner, the LIL functions that are the subject of LIL loss function evaluations 234, 236 (when minimized) encourage encoder 202 and the one or more initial layers 204 of decoders 206A, 206B to map the latent codes (Z3, Z4) corresponding to latently augmented CG faces 213 and latently augment actor faces 217 to match latent codes (Z1, Z3) generated without latent invariance augmentation (in blocks 211, 215). Doing so may make internal representations of image to image model 32 (e.g. latent codes) less sensitive to one or more factors of variation affected by latent invariance augmentation performed in blocks 211, 215. In general, the LIL loss function that is used for LIL loss function evaluations 234, 236 may comprise a number of terms that are representative of differences between their respective latent codes. In one particular embodiment, the LIL function that is used for LIL loss function evaluations 234, 236 comprise mean square error (MSE) and/or least square error (L2 norm) criterion functions. Other additional or alternative criterion functions could be included in the LIL function that is used for LIL loss function evaluations 234, 236.

FIG. 3B is a schematic depiction of a method 250 for training image-to-image model 32 that may be used to implement the block 30 image-to-image training for the FIG. 1A facial animation transfer method 10 having a plurality N of sets of actor input images 12 and/or CG character datasets 14 and/or the block 30′ image-to-image training for the FIG. 1B character retargeting method 10′ having a plurality N of sets of input CG source datasets 16 and/or CG character datasets 14 according to a particular embodiment. Method 250 may be performed by processor 62 of system 60 (FIG. 1C). Method 250 may be implemented using the FIG. 3A training scheme 200, except that method 250 is generalized to N identities (i.e. where the number N identities represents the total number of sets of input aligned actor faces 120 and input aligned CG faces 140 and represents the total number of autoencoders 201 (or decoders 206) in the generalized architecture). It will be appreciated that the number of identities is N=2 for the case of the FIG. 3A training scheme 200 (i.e. one set of input aligned actor faces 120, one set of input aligned CG faces 140 and two corresponding autoencoders 201A, 201B and two corresponding decoders 206A, 206B). Even though there are N autoencoders 201 in method 250 of FIG. 3B, the training scheme is analogous to that shown in FIG. 3A for the case of N=2 autoencoders 201, in the sense that all N autoencoders share the same encoder 202 and the same one or more initial layers 204 of their respective decoders 206. Where method 250 of FIG. 3B is used to implement block 30′ of image-to-image, the FIG. 3A training scheme 200 may be further altered to use aligned CG source face images in the place of aligned actor faces 120.

Method 250 starts with the same inputs as discussed above in connection with scheme 200 shown in FIG. 3A. Specifically, the inputs to method 250 comprise: aligned CG faces 140 and CG face segmentations 142 for each CG character identity; and aligned actor faces 120 and actor face segmentations 122 for each actor identity (or aligned CG source face images and CG source face segmentations for each CG source character). These inputs are not expressly shown in FIG. 3B to avoid over-cluttering the FIG. 3B illustration. The output of method 250 is a set of trainable parameters 290. Parameters 290 may comprise any trainable parameters (e.g. weights, biases and/or the like) of the N autoencoders 201. More specifically, parameters 290 may comprise the parameters of the common encoder 202 and the common one or more decoder layers 204 for the N autoencoders 201 as well as the parameters for the remaining layers of the decoders 206 for the N autoencoders (see FIG. 3A). Trained parameters 290 may form part of image-to-image model 32. As explained in more detail below, method 250 of the illustrated FIG. 3B embodiment involves separating the training process into batches of a single identity (e.g. each batch corresponding to a single actor or a single CG character) and evaluating the loss for the corresponding autoencoder 201 for each such batch/identity.

Method 250 starts in block 252 which involves initializing the trainable parameters of image-to-image model (i.e. initializing trainable parameter set 290). In some embodiments, block 252 may randomly initialize trainable parameters 290. In some embodiments, other techniques (such as assigning some prescribed values) to trainable parameters 290. Method 250 then proceeds to block 254 which involves initializing a counter variable i. The counter variable i is used to perform N iterations of batch loop 251. In the illustrated embodiment, the counter variable i is set to i=1 in block 252. Method 250 then proceeds to the inquiry of block 256. For each set of N−1 successive iterations, the block 256 inquiry will be negative and method 250 performs an iteration of batch loop 251. On each N^{th} iteration, the block 256 inquiry will be positive and method 250 proceeds to block 280 which is described in more detail below.

Batch loop 251 starts in block 260 which involves selecting (e.g. randomly selecting) one of the N identities and one of the corresponding N autoencoders 201 to work with for the remainder of batch loop 251. As alluded to above, batch loop 251 involves selecting a single identity (e.g. one actor, one source CG character or one CG character) and evaluating the loss for the corresponding autoencoder 201 in each batch. In some embodiments, the block 260 identity selection is structured such that every consecutive N iterations of batch loop 251 will cover each of the N identities once in a random order. Method 250 then proceeds to block 262 which involves selecting (e.g. randomly selecting) a number K of samples from within the block 260 identity. For example, if the block 260 selected identity is a CG character, then block 262 may involve selecting K poses/frames from among the aligned CG faces 140 (FIG. 3A) for that CG character. The number K of samples processed in each batch loop 251 may be a pre-set or configurable (e.g. user-configurable) parameter of image-to-image training method 250. In some embodiments, the number K of samples processed in each batch loop 251 may be in a range of 10-100 sample images, for example.

Method 250 then proceeds to block 264 which involves determining a loss for the current autoencoder 201 (i.e. the autoencoder 201 corresponding to the identity selected in block 260). The block 264 loss may be accumulated (e.g. added or averaged) across the K samples selected in block 262. That is, block 264 may comprise: computing a loss for each of the K samples; and then adding or averaging those per-sample losses to ascertain an accumulated loss for the current autoencoder 201. In some embodiments, for each of the K samples (k=1, 2, . . . K), the loss [symbol] ₖ may be determined in accordance with an equation of the form:

$${ℒ}_{k} = f ( {ℒ}_{IL , k} ) + g ( {ℒ}_{CCL , k} ) + h ( {ℒ}_{LIL , k} ) \qquad ( 1 )$$

where: [symbol] _{IL,k} is the above-discussed image loss (IL) function for the current autoencoder 201, [symbol] _{CCL,k} is the above-discussed latent cycle-consistency loss (CCL) function for the current autoecoder 201, [symbol] _{LIL,k} is the above-discussed latent invariance loss (LIL) and ƒ(⋅), g(⋅) and h(⋅) are suitably selected functions of their corresponding arguments. As discussed above, some embodiments do not use latent invariance loss (LIL), in which case equation (1) does not include the term h( [symbol] _{LIL,k}).

In some embodiments, as discussed above, the image loss (IL) function may comprise L1 norm (least absolute deviation) and SSIM (structural similarity index measure) terms, in which case the function ƒ( [symbol] _{IL,k}) may have the form

$$f ( {ℒ}_{IL , k} ) = a {ℒ}_{L 1 , k} + b {ℒ}_{SSIM , k} \qquad ( 1 a )$$

where [symbol] _{L1,k} is the L1 norm loss function for the current autoencoder 201, [symbol] _{SSIM,k} is the SSIM loss function for the current autoencoder 201 and a, b are configurable (e.g. user configurable or preconfigured) weight parameters. In some embodiments, the SSIM loss function [symbol] _{SSIM,k} may comprise those described in Wang et al. 2004. Image quality assessment: from error visibility to structural similarity. IEEE Transactions on Image Processing 13, 4 (2004), 600-612, which is hereby incorporated herein by reference.

To encourage autoencoders 201 to focus on the face region, both the input image (x_{i,k}) and the reconstructed image (\tilde{x}_{i,k}), from k^{th} sample from domain (identity) i, are masked by the background mask (mₓ_{_{i,k}}) using element-wise multiplication for each image channel (e.g. red (R), green (G), blue (B) values for each pixel). The reconstructed image (\tilde{x}_{i,k}) is computed with shared encoder 202 and the decoder 206 from the same (i^{t}h) domain as the input image (x_{i,k}) according to \tilde{x}_{i,k}=Dec_{i,k}(Enc(x_{i,k})). For example, referring to FIG. 3A, if the current identity/autoencoder 201 is a CG character, then the IL loss function may comprise IL function evaluation 226, the reconstructed image (\tilde{x}_{i,k}) may comprise pixels from CG face estimate 218 for the k^{th} sample based on latent code Z1, the ground truth image (x_{i,k}) may comprise pixel values from aligned CG face 140 for the k^{th} sample and mask value (mₓ_{ᵢ}_{,k}) may come from CG face segmentation 142 for the k^{th} sample.

In some embodiments, as discussed above, the latent cycle-consistency loss (CCL) function may comprise a mean square error between the latent codes derived from a domain i (current identity) and the latent codes derived from a decoded image of another domain j (another identity), in which case the equation (1) term g( [symbol] _{CCL,k}) may comprise a term of the form:

$$g ( {ℒ}_{CCL , k} ) = c {ℒ}_{CCL , k} = cE [ {( Enc ( {Dec}_{j} ( Enc ( {x}_{i , k} ) ) ) - Enc ( {x}_{i , k} ) )}^{2} ] \qquad ( 2 )$$

where c is a configurable (e.g. user configurable or preconfigured) weight parameter, E(⋅) is a mean operator, x_{i,k} is the k^{th} sample input image for the domain i, Enc(⋅) is the operation of encoder 202 and Decⱼ(⋅) is the operation of the j^{th} decoder 206. For example, referring to FIG. 3A and continuing with the example where the current identity/autoencoder is a CG character, then the CCL function evaluation may comprise CCL evaluation 230, x_{i,k} may correspond to the k^{th} sample input image from among aligned CG faces 140, Enc(⋅) may comprise the operation of encoder 202 and Decⱼ(⋅) may comprise the operation of actor decoder 206B. In the FIG. 3A scheme 200, there are only N=2 identities. Where N>2, the CCL loss used for the current identity/autoencoder 201 (domain i) may be determined by randomly selecting another identity (a domain J) that is different from the current identity/autoencoder 201 (domain i) being trained in batch loop 251.

In some embodiments, as discussed above, the latent invariance loss (LIL) function may comprise a mean square error between the latent codes derived from a domain i (current identity) and the latent codes derived from a domain i (current identity) that has undergone latent invariance augmentation, in which case the equation (3) term h( [symbol] _{IL,k}) may comprise a term of the form:

$$h ( {ℒ}_{LIL , k} ) = d {ℒ}_{LIL , k} = dE [ {( Enc ( Lat ( {x}_{i , k} ) ) - Enc ( {x}_{i , k} ) )}^{2} ] \qquad ( 3 )$$

where d is a configurable (e.g. user configurable or preconfigured) weight parameter, E(⋅) is a mean operator, x_{i,k} is the k^{th} sample input image for the domain i, Enc(⋅) is the operation of encoder 202 and Lat(⋅) is the operation of latent invariance augmentation. For example, referring to FIG. 3A and continuing with the example where the current identity/autoencoder is a CG character, then the LIL function evaluation may comprise LIL evaluation 234, x_{i,k} may correspond to the k^{th} sample input image from among aligned CG faces 140, Enc(⋅) may comprise the operation of encoder 202 and Lat(⋅) may comprise the operation of latent invariance augmentation block 211.

After the loss Lₖ is determined for each of the K samples (k=1, 2, . . . X) for the current identity/autoencoder 201, the total loss for the current identity/autoencoder 201 may be determined by accumulating (e.g. adding or averaging) the losses [symbol] ₖ for each of the K samples over the K samples to determine the total loss [symbol] for the current identity/autoencoder 201. Both the L1 norm term [symbol] _{L1,k} and the SSIM term [symbol] _{SSIM,k} can be aggregated and averaged over the batch Xᵢ according to an equation of the form:

$$ℒ = \frac{1}{\vert {X}_{i} \vert} {\sum }_{{x}_{i} ∈ {X}_{i}} {f}_{c} ( {\tilde{x}}_{i} \cdot {m}_{{x}_{i}} , {x}_{i} \cdot {m}_{{x}_{i}} ) ) \qquad ( 4 )$$

with different criterion functions ƒ_{c} (e.g. the L1 norm criterion function or the SSIM criterion function). Similarly, the CCL loss can be aggregated and averaged over the batch Xᵢ according to an equation of the form:

$${ℒ}_{CCL} = \frac{1}{\vert {X}_{i} \vert} {\sum }_{{x}_{i} ∈ {X}_{i}} cE [ {( Enc ( {Dec}_{j} ( Enc ( {x}_{i} ) ) ) - Enc ( {x}_{i} ) )}^{2} ] \qquad ( 5 )$$

Similarly, the LIL loss can be aggregated and averaged over the batch Xᵢ according to an equation of the form:

$${ℒ}_{LIL} = \frac{1}{\vert {X}_{i} \vert} {\sum }_{{x}_{i} ∈ {X}_{i}} dE [ {( Enc ( Lat ( {x}_{i} ) ) - Enc ( {x}_{i} ) )}^{2} ] \qquad ( 6 )$$

Determination of the total loss for the current identity/autoencoder 201 concludes block 264 of method 250.

Method 250 then proceeds to block 268 which involves determining and accumulating loss gradients to obtain determined and accumulated loss gradients 272. Determining and/or accumulating loss gradients 272 in block 268 comprises computing partial derivatives of the block 264 loss for the current identity/autoencoder with respect to each of the trainable parameters 290 of image-to-image model 32 and may comprise the use of a suitable back-propagation algorithm. Loss gradients 272 may be determined in block 268 for each of the trainable parameters 290 that are exclusive parameters of the current identity/autoencoder 201 and loss gradients 272 may be accumulated in block 268 for each of the trainable parameters 290. It will be observed that the gradients corresponding to trainable parameters 290 shared between identities may be accumulated in each iteration of batch loop 251, but that gradients corresponding to trainable parameters that are specific to specific decoders 206 only accumulate once for each N iterations of batch loop 251 because there is only one batch in batch loop 251 that produces losses affecting trainable parameters corresponding to specific decoders 206. Loss gradients 272 may be accumulated in block 268 by adding the loss gradients 272 determined for each shared trainable parameter in each iteration of batch loop 251 to one another. Loss gradients 272 may be additionally or alternatively accumulated in block 268 by storing the loss gradients for subsequent accumulation.

Once the loss gradients 272 are determined and accumulated in block 268, method 250 proceeds to block 276 which involves incrementing the counter i before returning to block 256. Method continues to iterate through batch loop 251 for each of the N identities. As discussed above, block 260 may be structured such that every consecutive N iterations of batch loop 251 will cover each of the N identities once in a random order. The output of each iteration of batch loop 251 is a set of determined and accumulated loss gradients 272.

When the counter i reaches i=N, then the block 256 inquiry will be positive, in which case method 250 proceeds to block 280 which involves dividing the accumulated gradients 272 for the shared trainable parameters 290 by N. As discussed in relation to the FIG. 3A architecture, the shared trainable parameters 290 include those parameters of encoder 202 and those parameters of the one or more initial layers 204 of the N respective decoders 206.

Method 250 then proceeds to block 284 which involves using the gradients (the identity-specific gradients 272 determined in each iteration of block 268 and the shared gradients 272 accumulated over the iterations of block 268 and/or accumulated in block 280) together with a learning rate (which is a pre-set or configurable (e.g. user-configurable) parameter of image-to-image training method 250 to update the trainable parameters 290, thereby obtaining updated trainable parameters 290. For a given parameter W, the block 284 gradient update may comprise implementing functionality of the form:

$${W}_{new} = {W}_{old} - α \frac{\partial J}{\partial W} \qquad ( 7 )$$

where W_{new} is the updated parameter value, W_{old} is the existing parameter value prior to block 284, a is the learning rate and

$$\frac{\partial J}{\partial W}$$

is the gradient 272 for the parameter W. In some embodiments, block 284 may involve use of a suitable optimization algorithm together with its meta-parameters to update trainable parameters 290. One non-limiting example of such an optimization algorithm is the so-called Adam optimization technique, with its meta-parameters described, for example, in Kingma et al. 2014a. Auto-Encoding Variational Bayes. In 2^{nd} International Conference on Learning Representations, ICLR 2014, Banff, AB, Canada, Apr. 14-16, 2014, Conference Track Proceedings, Yoshua Bengio and Yann LeCun (Eds.)., which is hereby incorporated herein by reference. In some embodiments, the meta-parameters of this Adam optimization technique may comprise β₁=0.5, β₂=0.999 and learning rate of α=5e⁻⁵.

After determining updated parameters 290, method 250 proceeds to block 288 which involves resetting the gradients 272 to zero in preparation for another iteration. Method 250 then proceeds to block 292 which involves an inquiry into whether the training is finished. There are many different loop-exit conditions that could be used to make the block 292 evaluation. Such loop-exit conditions may be user-specified or may be pre-configured. Such loop-exit conditions include, by way of non-limiting example, a number of iterations of branch loop 251, one or more threshold loss amounts, one or more threshold gradient amounts, one or more threshold changes in trainable parameters 290, user intervention and/or the like. If the block 292 evaluation is negative, then method 250 proceeds to block 296 where method 250 loops back to block 254 repeats the whole process again. This process of iterating from blocks 254 through to block 292 continues until the block 292 loop-exit evaluation is positive and method 250 ends.

In some embodiments, the inventors have used a number of iterations of branch loop 251 in a range of 10⁵N-10⁶N as the loop exit condition for block 292.

The description of method 250 presented above refers to inputs as aligned CG faces 140 for each CG character identity and aligned actor faces 120 for each actor (or aligned CG source faces for each CG source character identity). As discussed above in relation to FIG. 3A, these images (aligned CG faces 140 and aligned actor faces 120 (or aligned CG source faces)) may be respectively augmented in blocks 210A, 210B, 211, 214A, 214B, 215 to provide augmented CG faces 212A, 212B, 213 and augmented actor faces 216A, 216B, 217 (or augmented CG source faces) prior to using these images in method 250. References to aligned CG faces 140 and aligned actor faces 120 (or aligned CG source faces) described herein in connection with method 250 should be understood to include the possibility of augmented CG faces 212A, 212B, 213 and augmented actor faces 216A, 216B, 217 (or augmented CG source faces) augmented in blocks 210A, 210B, 211, 214A, 214B, 215.

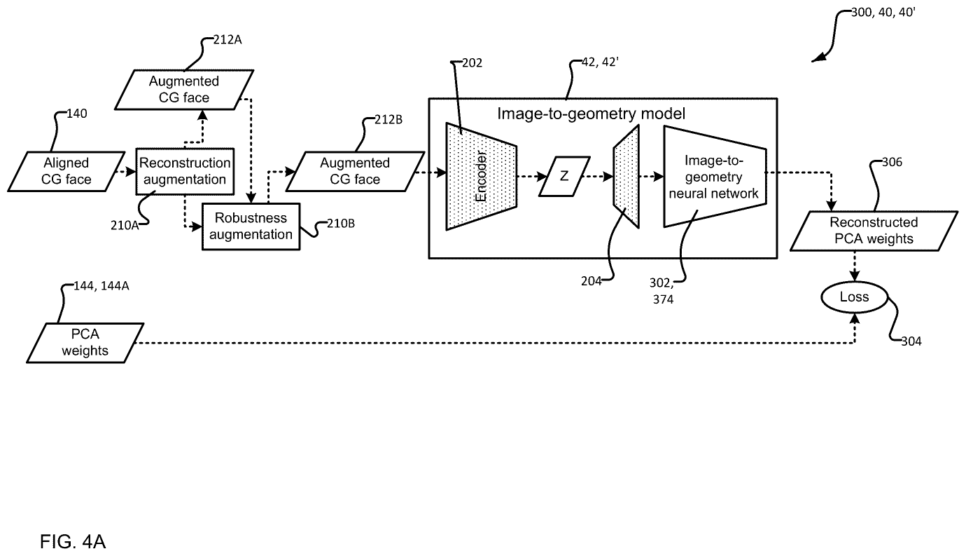

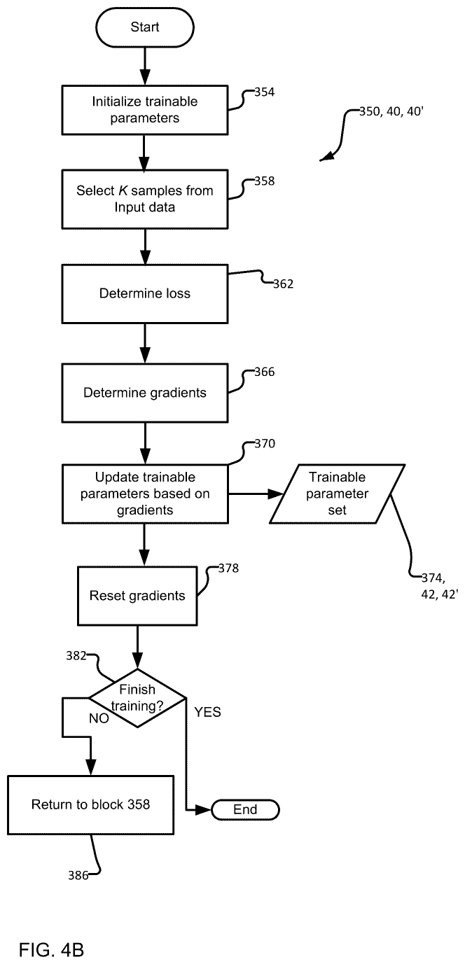

FIG. 4A is a schematic depiction of a training scheme 300 showing the computation of a loss term that may be used to implement the block 40 training of image-to-geometry model 42 for one CG identity/character for the FIG. 1A facial animation transfer method 10 or the block 40′ training of image-to-geometry model 42′ for one CG identity/character for the FIG. 1B character retargeting method 10′ according to a particular embodiment. The block 40 training of image-to-geometry model 42 and/or the block 40′ training of image-to-geometry model 42′ may be performed by processor 62 of system 60 (FIG. 1C) using scheme 300. Training scheme 300 uses a supervised training scheme with inputs comprising pairs of aligned CG faces 140 and corresponding sets of PCA weights 144A (from among PCA decompositions 144—see FIG. 2B) for the CG character/entity being trained. Where training scheme 300 is used for the block 40′ training of image-to-geometry model 42′ for one CG identity/character for the FIG. 1B character retargeting method 10′, the aligned CG faces 140 input into training scheme 300 may comprise aligned CG character faces corresponding to any of the CG character datasets 14 input to method 10′. In some embodiments, where CG source character datasets 16 comprise full 3D CG representations of source characters (e.g. capable of being compressed with suitable blendshape decompositions), then the aligned CG faces 140 and blendshape (e.g. PCA) weights 144A input into training scheme 300 may be obtained from a CG source character dataset 16. In some embodiments, user input may be used to establish correspondence between input aligned CG faces 140 and blendshape weights 144A, although such user input is not required where this correspondence is known.

As can be seen from FIG. 4A, image-to-geometry training scheme 300 uses information from the CG character domain for the CG character/entity being trained and does not require information from the actor domain. Specifically, image-to-geometry training scheme 300 receives as input pairs of aligned CG faces 140 and corresponding sets of PCA weights 144A (from among PCA decompositions 144—see FIG. 2B or from PCA decompositions of CG source character poses) and uses these inputs to train image-to-geometry model 42 for the CG character/entity being trained so that, during inference, image-to-geometry model 42, 42′ can receive an image of a CG face and predict a set of PCA weights (and corresponding 3D mesh geometry) corresponding to that CG face. Image-to-geometry model 42, 42′ comprises the shared elements of the trained image-to-image model 32. Specifically, image-to-geometry model 42 comprises encoder 202 and the one or more initial layers 204 of decoders 206 (see FIG. 3A). Image-to-geometry model 42, 42′ also comprises image-to-geometry neural network 302 that is specific to the CG character/entity being trained. The parameters of encoder 202 and the one or more initial decoder layers 204 may be fixed during training of image-to-geometry model 42, 42′ and image-to-geometry neural network 302 may comprise all of the trainable parameters 374 of image-to-geometry model 42, 42′. In some embodiments, image-to-geometry neural network 302 comprises a fully connected neural network, although this is not necessary. In some embodiments, image-to-geometry neural network 302 comprises linear activation functions, although this is not necessary.

Image-to-geometry training scheme 300 also comprises some processing steps of image-to-image training scheme 200 and/or image-to-image training method 250. Specifically, image-to-geometry training scheme 300 receives aligned CG faces 140 and uses random image augmentation in block 210A, 210B to obtain augmented CG faces 212B in the same manner as the corresponding blocks 210A, 210B of image-to-image training scheme 200. As discussed above, this block 210A, 210B random image augmentation may comprise one or more of: affine transformations in block 210A and optional grid transformation in block 210B. The random image augmentation in blocks 210A, 210B may additionally comprise scaling the input resolution to match the expected resolution for image-to-geometry model 42. In some non-limiting embodiments, images are scaled to 128×128 pixels, although this is not necessary. References to aligned CG faces 140 described herein in connection with image-to-geometry training scheme 300 and associated training methods should be understood to include the possibility of augmented CG faces 212A, 212B (collectively, augmented CG faces 212) augmented in block 210A and/or block 201B.

As discussed above in connection with FIG. 2B, each aligned CG face 140 is derived from a corresponding pose/frame of CG character dataset 14 (or, in the case of character retargeting method 10′, a CG source character dataset 16). Aligned CG faces 140 input to image-to-geometry training scheme 300 are paired with corresponding PCA weights 144A in the sense that each set of corresponding PCA weights 144A and each aligned CG face 140 input to image-to-geometry training scheme 300 are derived from the same pose/frame of CG character dataset 14 or from the same pose/frame of CG source character dataset 16.

Image-to-geometry model training scheme 300 according to the FIG. 4A embodiment involves the use of a loss function (also known as an objective function) 304 which is minimized during the image-to-geometry training process to determine the weights (trainable parameters) 374 for image-to-geometry neural network 302 and to thereby generate a trained image-to-geometry model 42, 42′ for the CG character/identity being trained. Image-to-geometry model training scheme 300 has one loss function 304 which compares input PCA weights 144A obtained from PCA decomposition 144 (see FIG. 2) to reconstructed PCA weights 306 output from image-to-geometry model 42, 42′. In general, loss function 304 may comprise a number of terms that are representative of differences between the input PCA weights 144A and the reconstructed PCA weights 306. In some embodiments, loss function 304 comprises a root mean squared error (L2 norm) criterion function. In some embodiments, loss function 304 additionally or alternative comprises a mean squared error (MSE) criterion function. Other additional or alternative criterion functions could be included in loss function 304.

FIG. 4B is a schematic depiction of a method 350 for training image-to-geometry model 42, 42′ that may be used to implement the block 40 image-to-geometry training for one CG character/identity for the FIG. 1A facial animation transfer method 10 and/or the block 40′ image-to-geometry training for one CG character/identity for the FIG. 1B character retargeting method 10′ according to a particular embodiment. Method 350 may be performed by processor 62 of system 60 (FIG. 1C). Method 350 may be implemented using the FIG. 4A training scheme 300. Method 350 of FIG. 4B is applicable to a single CG character/identity 14. In some embodiments, where CG source character/identity datasets 16 comprise full 3D CG representations of source characters (e.g. capable of being compressed with suitable blendshape decompositions), then method 350 may be applicable to a single source CG character/identity. In the case where there are a plurality (e.g. N) CG identities, method 350 may be performed a corresponding plurality of times.

Method 350 commences in block 354 which involves initializing trainable parameters 374 of image-to-geometry model 42. As discussed above, image-to-geometry neural network 302 comprises all of the trainable parameters 374 of image-to-geometry model 42, 42′ and the previously trained parameters of encoder 202 and one or more initial decoder layers 204 are fixed. Method 350 then proceeds to block 358 which involves selecting a number K of samples of input data (each sample comprising an aligned CG face 140 (or, more particularly, an augmented CG face 212) and a set of PCA weights 144A derived from the same pose/frame of CG character dataset 14). The number K of samples processed in each loop of method 350 may be a pre-set or configurable (e.g. user-configurable) parameter. In some embodiments, the number K of samples processed in each loop of method 350 may be in a range of 1-100 samples. In one particular example embodiment K=16.

Method 350 then proceeds to block 362 which involves determining the loss 304 for the current K samples. That is, block 362 may comprise: computing a loss for each of the K samples; and then adding or averaging those per-sample losses to ascertain an accumulated loss for the current batch of K samples. Once the loss is determined in block 362, then method 350 proceeds to block 366 which involves determining the gradients for each trainable parameter 374 of image-to-geometry model 42, 42′ based on the block 366 loss. Determining gradients in block 366 comprises computing partial derivatives of the block 362 loss for the current set of K samples with respect to each of the trainable parameters 374 of image-to-geometry model 42, 42′. Method 350 then proceeds to block 370 which involves updating the trainable parameters 374 of image-to-geometry model 42, 42′ based on the block 366 gradients together with a learning rate (which is a pre-set or configurable (e.g. user-configurable) parameter of image-to-geometry training method 350). For a given trainable parameter 374, updating the trainable parameter 374 in block 370 may comprise implementing functionality of the form:

$${W}_{new} = {W}_{old} - γ \frac{\partial J}{\partial W} \qquad ( 8 )$$

where W_{new} is the updated parameter value, W_{old} is the existing parameter value prior to block 370, γ is the learning rate, J is the block 362 loss and

$$\frac{\partial J}{\partial W}$$

is the block 366 gradient for the parameter W. In some embodiments, block 370 may involve use of a suitable optimization algorithm together with its meta-parameters to update trainable parameters 374. One non-limiting example of such an optimization algorithm is the so-called Adam optimization technique discussed above. In some embodiments, the meta-parameters of this Adam optimization technique may comprise β₁=0.5, β₂=0.999 and learning rate of α=5e⁻⁵.

After determining updated parameters 374, method 350 proceeds to block 378 which involves resetting the gradients to zero in preparation for another iteration. Method 350 then proceeds to block 382 which involves an inquiry into whether the training is finished. There are many different loop-exit conditions that could be used to make the block 382 evaluation. Such block 382 loop-exit conditions could be user configurable or pre-defined. Such loop-exit conditions include, by way of non-limiting example, a number of iterations of the loop of method 350, one or more threshold loss amounts, one or more threshold gradient amounts, one or more threshold changes in trainable parameters 374, user intervention and/or the like. If the block 382 evaluation is negative, then method 350 proceeds to block 386 where method 350 loops back to block 358 repeats the whole process again. This process of iterating from blocks 358 through to block 386 continues until the block 382 loop-exit evaluation is positive and method 350 ends.

In some embodiments, the inventors have used a number of iterations in a range of 10⁵-10⁶ as the loop exit condition for block 382.

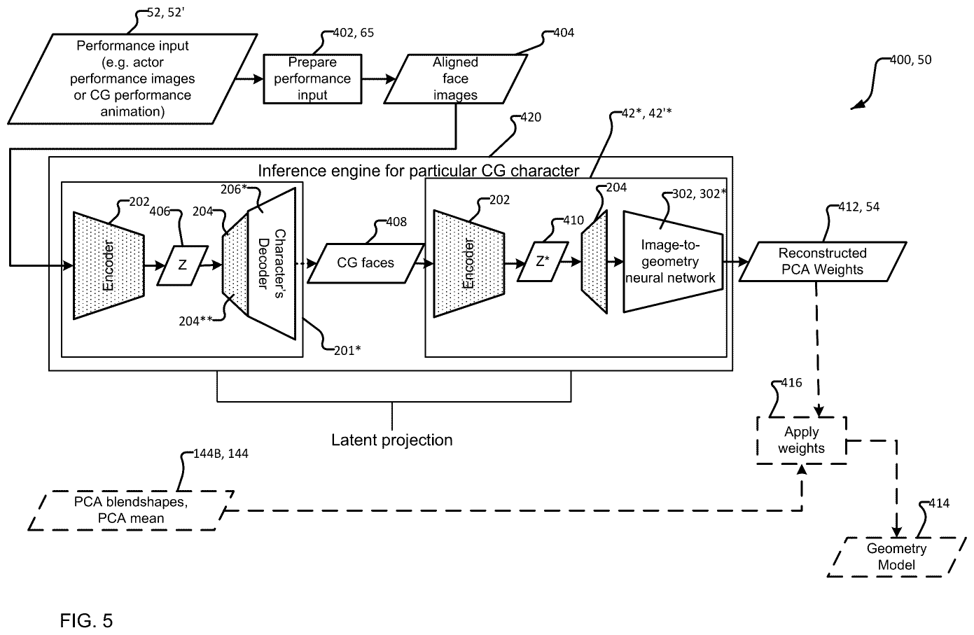

FIG. 5 is a schematic depiction of a method 400 for inferring a 3D CG representation 54 corresponding to performance input 52 that may be used to implement the block 50 image-to-geometry inference and the block 65 image preparation for the FIG. 1A facial animation transfer method 10 and/or the block 50′ image-to-geometry inference and the block 65′ image preparation for the FIG. 1B character retargeting method 10′ according to a particular embodiment. Method 400 may be performed by processor 62 of system 60 (FIG. 1C). Method 400 may be implemented using aspects of image-to-image model 32, 32′ and image-to-geometry model 42, 42′. As discussed above, performance input 52 may comprise actor performance images (e.g. video of an actor). Notably, the actor associated with performance input 52 need not be the same actor as that associated with any of training actor images 12 (FIG. 1A). In embodiments where performance input 52 are captured by an HMC, the HMC camera that best frames the actor may be chosen for performance input 52. Performance input 52 may additionally or alternatively comprise a CG character animation (generated with an animation rig or otherwise) from which image frames may be rendered. In such implementation, the CG character associated with performance input 52 need not be the same character that is the source of any of CG character datasets 14 or source CG character datasets 16 used in training. Performance input 52 may additionally or alternatively comprise an already rendered video (e.g. a series of image frames) of a CG character performance. Once again, in such implementations, the CG character associated with performance input 52 need not be the same character that is the source of any of CG character datasets 14 or source CG character datasets 16 used in training. Output 3D CG representations 54 may be from the same CG character or from a different CG character as performance input 52, provided that the CG characters available for output 3D CG representations 54 are among the identities for which image-to-image model 32, 32′ and image-to-geometry model 42, 42′ are trained (i.e. from one of CG character datasets 14 used in the training blocks of method 10 or from one of CG character datasets 14 or CG source character datasets 16 used in the training blocks of method 10′).

Method 400 commences in block 402 implements the block 65, 65′ image preparation functionality of methods 10, 10′. Block 402 may involve preparing performance input 52 to provide aligned face images 404 for further processing. The block 402 image preparation may comprise steps similar to the step 20 (method 100) image preparation used on the training data, including: rendering (in the case where performance input 52 comprise a CG animation not in 2D image format or performance input 52 is otherwise not provided in 2D image format), removing markers from performance input 52 (e.g. block 105), face detection (e.g. blocks 106, 106A), landmark detection (e.g. blocks 108, 108A), face alignment (e.g. blocks 110, 110A, 110B) and, if necessary, resizing images to match the resolution (e.g. 128×128 pixels) used for training image-to-image model 32, 32′ and image-to-geometry model 42, 42′. The output of the block 402 image-preparation procedure (referred to herein as aligned face images 404) may comprise cropped and resized images of a face having a desired resolution. References to input performance input 52 described herein in connection with method 400 should be understood to include the possibility of aligned face images 404 prepared in accordance with block 402.

Aligned face images 404 are then provided to an inference engine 420. Even though performance input 52 could comprise input images of any actor or any CG character (and are not limited to actors or CG characters in associated with which image-to-image model 32, 32′ and image-to-geometry model 42, 42′ are trained), inference engine 420 is specific to one CG character—i.e. the CG character for which output 3D CG representation 54 is desired, referred to herein as the “target CG character”. The target CG character may be one of the CG characters in associated with which image-to-image model 32, 32′ and image-to-geometry model 42, 42′ are trained—i.e. one of CG character datasets 14 and/or a CG source dataset 16 (in the case of character retargeting). In the illustrated embodiment, inference engine 420 comprises the autoencoder 201* (including the shared encoder 202 and one or more initial decoder layers 204 and the target-CG-character specific decoder 206*) corresponding to the target CG character and the image-to-geometry neural network 302* corresponding to the target CG character. The target CG character autoencoder 201* is an optional component of inference engine 420 and may be used to infer reconstructed CG faces 408 from aligned face images 404. Then, encoder 202 and one or more initial decoder layers 204 may then be used to process reconstructed CG faces 408, whereupon the target-CG-character specific image-to-geometry neural network 302* is used to map to reconstructed PCA weights 412. As discussed above, reconstructed PCA weights 412 represent a form of representation of a 3D CG face geometry 54, since PCA weights 412 can be used to reconstruct a 3D mesh (including 3D vertex locations) using PCA blendshapes (basis matrix) 144B and PCA mean vector 144C (obtained in method 100 (block 38) of FIG. 2B) or the PCA blendshapes (basis matrix) and PCA mean vector associated with the PCA decomposition of CG source character dataset 16. This last step (conversion of output reconstructed PCA weights 412 into a 3D geometry model (mesh) 414) is shown in FIG. 5 as an optional step 416. It will be appreciated that 3D geometry model 414 is another form of representation of a 3D CG face geometry 54. It will further be appreciated that either of these 3D CG face geometry representations 54 (PCA weights 412 or 3D geometry model 414) could be used to render the CG character's face using a suitable animation rendering engine (not shown).

A portion of inference engine 420 and the corresponding process of re-encoding performance input 52 may be understood to be a form of latent projection, since latent code 406 is “projected” (via decoder 206* and second encoder 202) to be a second latent code Z* which may be closer to the data with which image-to-geometry neural network 302* was trained. In this respect, autoencoder 201* may be optional and in some embodiments, image-to-geometry model 42*, 42′* may be used to implement inference engine 420 without autoencoder 201* (e.g. by receiving aligned face image 404 directly (instead of CG faces 408) and outputting reconstructed PCA weights 412 (reconstructed 3D CG face geometry 54). Equivalently, image-to-geometry neural network 302 may be connected to receive output from decoder 204**, in which case character decoder 206 and the portions of image-to-geometry model 42*, 42′* other than image-to-geometry neural network 320 are not required. In some embodiments, the combination of the shared element 204 of decoder 206 and image-to-geometry neural network 302 may be referred to herein as a “latent-to-3D network” which, after suitable training as discussed herein, receives latent codes Z generated by encoder 202 and outputs a corresponding 3D CG representation 54 of the output CG character (e.g. PCA weights 412 corresponding to a pose of the output CG character). In some embodiments, autoencoders 201 may be constructed such that only the trainable parameters of encoders 202 are shared and all of the parameters of decoders 206 are character specific, in which case image-to-geometry neural network 302 may be considered to be a “latent-to-3D network” which, after suitable training, receives latent codes Z generated by encoder 202 and outputs a corresponding 3D CG representation 54 of the output CG character (e.g. PCA weights 412 corresponding to a pose of the output CG character).

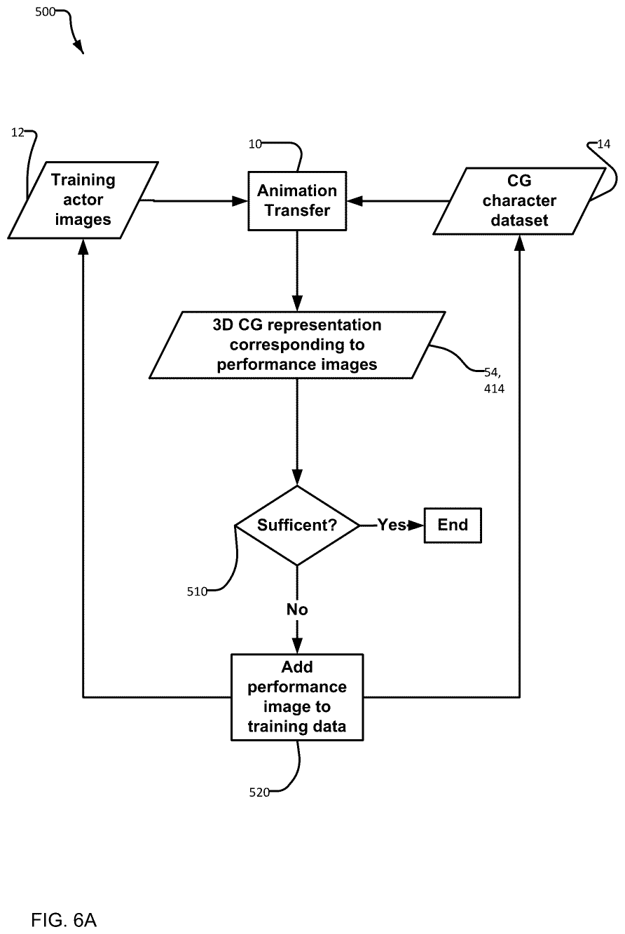

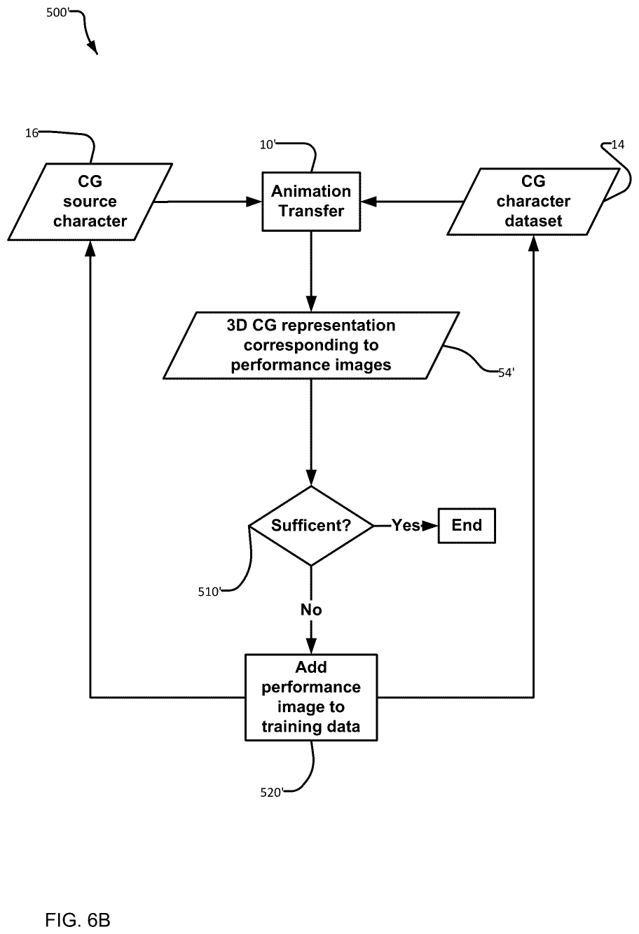

FIG. 6A is a broad schematic depiction of a method 500 for the verification of facial animation transfer according to a particular example embodiment. Method 500 includes method 10 as described elsewhere herein. Block 510 involves inspecting each 3D CG representation 54 (or 3D geometry model 414) and determining if it is sufficient. Sufficiency may be determined based on for example one or more of accuracy, facial features, facial expression, etc., present in 3D representation 54 (or 3D geometry model 414). Comparisons may be made between 3D representation 54 (or 3D geometry model 414) and the corresponding performance input 52. For example, the facial expressions in 3D representation 54 may be compared to the facial expressions in performance input 52. Comparisons may be made irrespective of changing factors present in performance input 52, such as helmet placement, background, illumination, etc. When it is determined that each 3D CG representations 54 (or 3D geometry model 414) is sufficient method 500 ends. Otherwise, in block 520, performance input 52 is wholly or partially integrated into actor images 12 or to CG character dataset 14 for further training. In some embodiments, only the one or more frames of performance input 52 associated with insufficient 3D CG representations 54 may be integrated into actor images 12 or to CG character dataset 14 for further training. To add to character dataset 14 for further training, block 520 may apply standard motion capture techniques (examples of which are discussed elsewhere herein) to performance input 52. Facial animation transfer method 10 may then be re-run. Method 10 may be re-run until it is determined that each CG representation 54 (or 3D geometry model 414) is sufficient.

FIG. 6B is a broad schematic depiction of method 500′ for the verification of facial animation transfer between CG characters according to a particular example embodiment. Method 500′ has aspects that are the same or similar to method 500 as applied to character retargeting method 10′ as described elsewhere herein. Like numbering represents like elements. Block 510′ inspects CG character 3D representations 54′ to determine if CG character 3D representations 54′ are sufficient. If each CG character 3D representations 54′ is sufficient, method 500′ ends. Otherwise performance input 52′ is wholly or partially integrated into CG source character dataset 16 in block 520′. Block 520′ may apply standard facial animation retargeting methods, such as any one or combination of those disclosed, for example by: Noh et al. 2001. Expression Cloning. SIGGRAPH'01 (retrieved 13 Apr. 2022 from https://dl.acm.org/doi/10.1145/383259.383290); Saito. 2013. Smooth Contact-Aware Facial Blendshapes. DIGIPRO '13 (retrieved 13 Apr. 2022 from https://dl.acm.org/doi/abs/10.1145/2491832.2491836); Sumner et al. 2004. Deformation Transfer for Triangle Meshes. ACM Trans. Graph. 23, 3 (August 2004), 7 pages (retrieved 13 Apr. 2022 from https://dl.acm.org/doi/10.1145/1015706.1015736); and Bickel et al. 2008. Pose-Space Animation and Transfer of Facial Details, ACM SIGGRAPH Symposium on Computer Animation, all of which are hereby incorporated herein by reference. Character retargeting method 10′ may then be re-run. Method 10′ may be re-run until it is determined that each CG character representation 54′ (or geometry model 414) is sufficient.

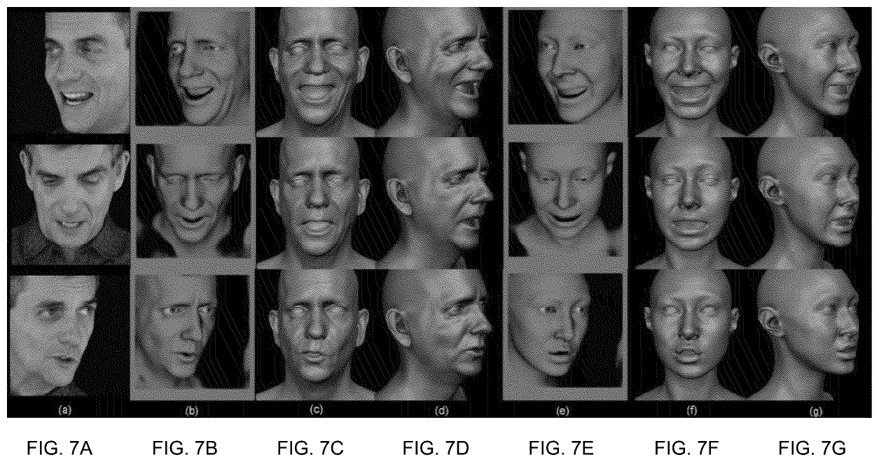

FIG. 7 shows experimental results obtained using the FIG. 1A facial animation transfer method 10 for two different CG characters, one of which is an actor-specific character (shown in FIGS. 7B-7D) and one of which is an arbitrary character (shown in FIGS. 7E-7F). FIG. 7A shows input performance input 52 from an actor. FIGS. 7B and 7E show corresponding decoded CG character images 408 (see FIG. 5) for the actor-specific and arbitrary CG characters respectively. FIGS. 7C and 7F show frontal view output 3D geometries (3D CG face geometries 54) of CG the actor-specific and arbitrary CG characters respectively. FIGS. 7D and 7G show side view output 3D geometries (3D CG face geometries 54) of CG the actor-specific and arbitrary CG characters respectively. The FIG. 7 results were obtained using (as actor images 12) a 3 minute long video (captured at a suitable frame rate (e.g. 24 fps)) of a male actor performing a line and showing some extreme poses, with the actor situated in front of a black background screen in a room that is well-lit, but with no particular lighting restrictions. The actor was permitted to move his head around while speaking.

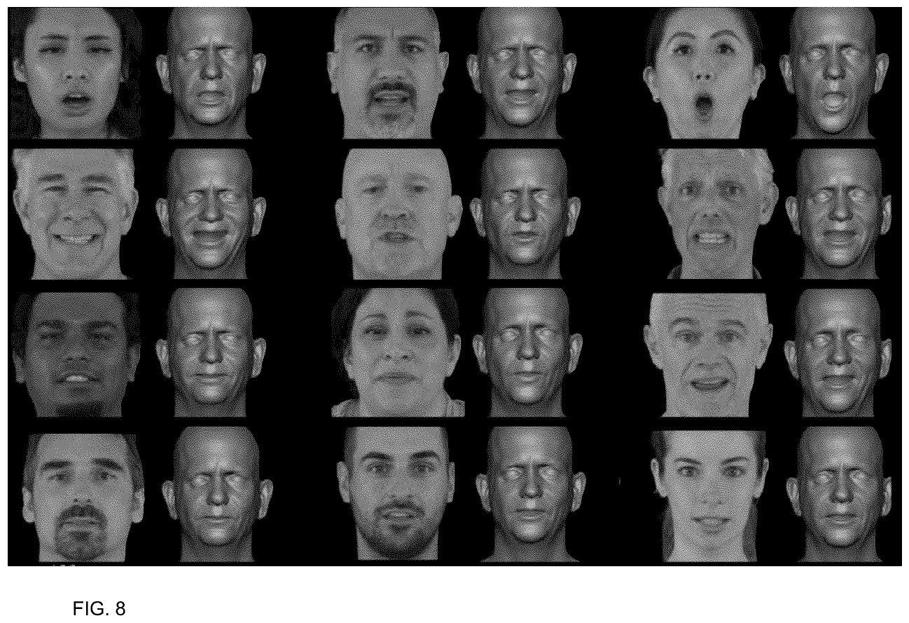

FIG. 8 shows experimental results obtained using the FIG. 1A facial animation transfer method for a circumstance where a single CG character (single CG character dataset 14) was trained along with actor images 12 from twelve different actors, with 2-3 minutes per actor obtained at 60 fps under similar actor-capture conditions as those of FIG. 7. Each pair of panels in FIG. 8 shows an image from among each set 12A of actor images 12 and corresponding frontal view output 3D geometries (3D CG face geometries 54).

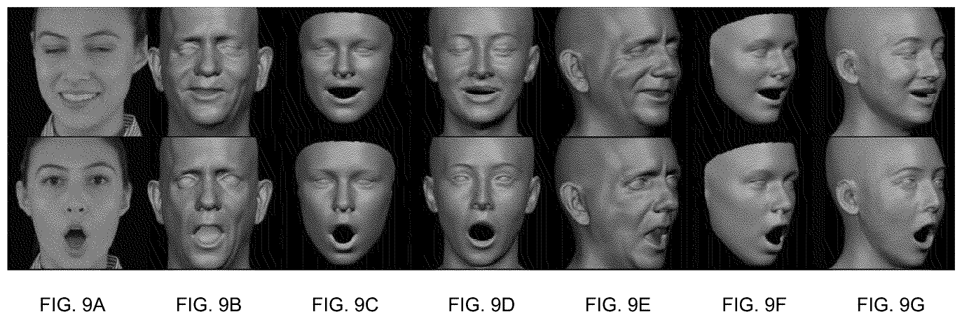

FIG. 9 shows experimental results for a situation where image-to-image model 32 and image-to-geometry model 42 were trained with the data from FIG. 8 (i.e. actor images 12 from twelve different actors, with 2-3 minutes per actor obtained at 60 fps and a single CG character dataset 14) but with performance input 52 comprising actor performance images from an actor that was previously unseen and comparison of these results with prior art techniques. That is, the actor from whom performance input 52 originated was not used to train image-to-image model 32 or image-to-geometry model 42. Specifically, FIG. 9A shows a pair of input actor performance images (performance input 52); FIG. 9B shows corresponding frontal view output geometry (3D face geometry 54) obtained using method of FIG. 1A; FIG. 9C shows, for comparison, corresponding frontal view output geometry obtained using the 3DDFA-V2 technique disclosed by Guo et al. 2020. Towards Fast, Accurate and Stable 3D Dense Face Alignment. In Proceedings of the European Conference on Computer Vision (ECCV); and FIG. 9D shows, for comparison, corresponding frontal view output geometry obtained using the DECA technique disclosed by Feng et al. 2021. Learning an Animatable Detailed 3D Face Model from In-The-Wild Images. ACM Transactions on Graphics, (Proc. SIGGRAPH) 40, 8. FIGS. 9E, 9F and 9G respectively depict, for comparison, side view output geometries using method 10 of FIG. 1A, the 3DDFA-V2 technique and the DECA technique.

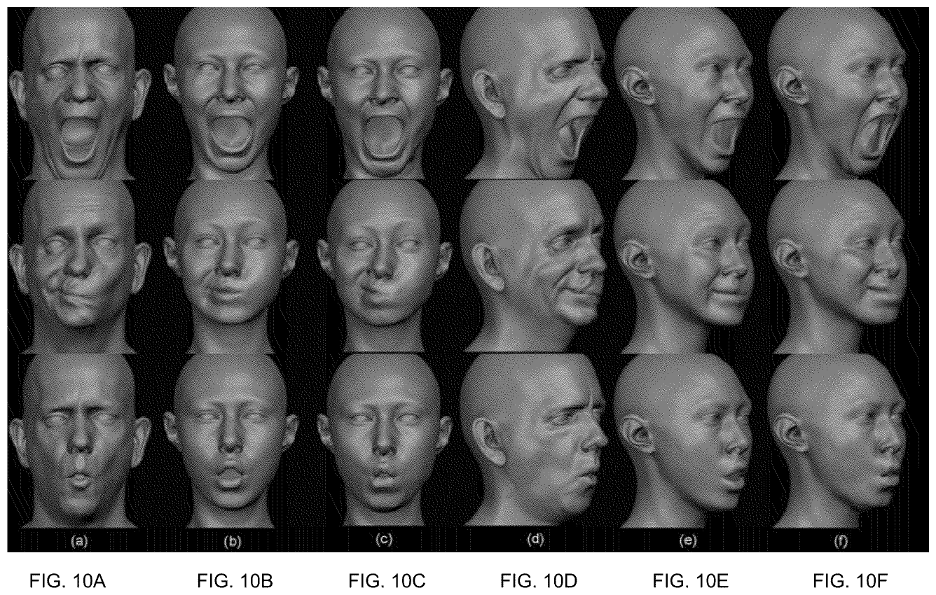

FIG. 10 shows experimental results for the use of the FIG. 1B character retargeting method 10′ having one CG source character dataset 16 (CG character A) and one CG character dataset 14 (CG character B). Specifically, FIG. 10A shows front views of CG source character dataset 16 for character A, FIG. 10B shows corresponding front views of output geometry (3D face geometry 54′) for CG character B, FIG. 10C shows (for baseline comparison) corresponding front views of output geometry for CG character B obtained using a prior art character retargeting technique involving corresponding animation rigs for both CG character A and CG character B. FIG. 10D shows side views of CG source character dataset 16 for character A, FIG. 10E shows corresponding side views of output geometry (3D face geometry 54′) for CG character B, FIG. 10F shows (for baseline comparison) corresponding side views of output geometry for CG character B obtained corresponding animation rigs.

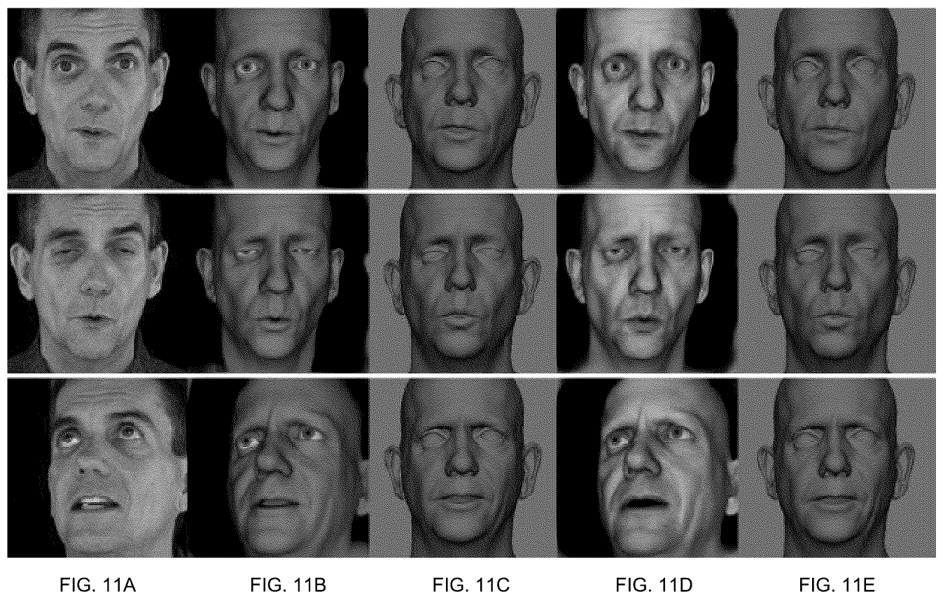

FIG. 11 shows experimental results for modifying the FIG. 1A facial animation transfer method by varying the surface shader used for rendering CG character images during training (e.g. at block 134 of the FIG. 2 data preparation method 100). Specifically, FIG. 11A shows performance input 52 comprising actor images, FIG. 11B shows corresponding inferred CG face images 408 (see FIG. 5) using models trained using rendering with constant color in the surface shader, FIG. 11C shows corresponding CG output geometry 54 using models trained using rendering with constant color in the surface shader, FIG. 11D shows corresponding inferred CG face images 408 (see FIG. 5) using models trained using rendering with actor specific textures with high frequency skin details in the surface shader, and FIG. 11E shows corresponding CG output geometry 54 using models trained using rendering with actor specific textures with high frequency skin details in the surface shader. There were no visible differences in the quality of the regressed output geometries 54, but the inventors observed increased robustness in the facial landmark detection model when using rendering with actor specific textures with high frequency skin details in the surface shader, suggesting that such rendering details may help to reduce temporal alignment instabilities in some circumstances.

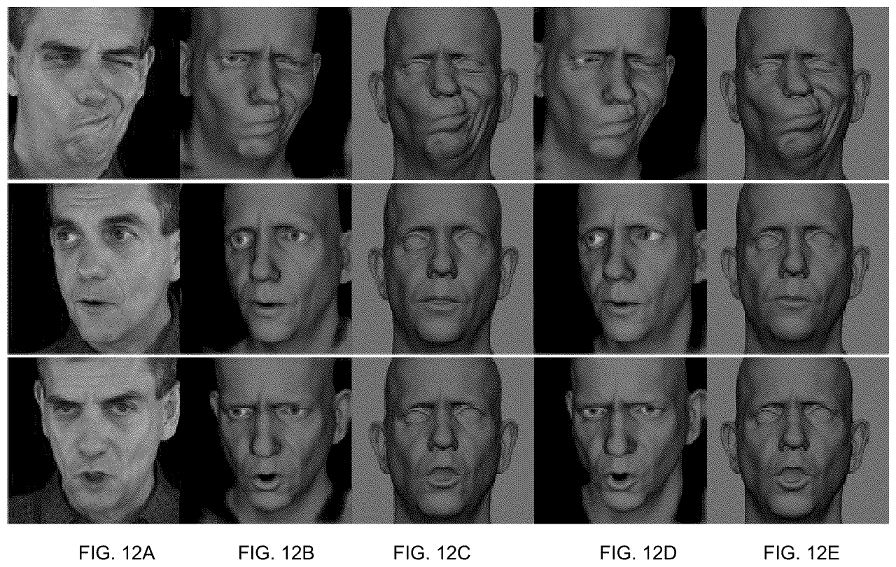

FIG. 12 shows experimental results for modifying the FIG. 1A facial animation transfer method by varying the eye gaze directions used for rendering CG character images during training (e.g. at block 134 of the FIG. 2 data preparation method 100). Specifically, FIG. 12A shows performance input 52 comprising actor images, FIG. 12B shows corresponding inferred CG face images 408 (see FIG. 5) using models trained using rendering with constant eye gaze direction, FIG. 12C shows corresponding CG output geometry 54 using models trained using constant eye gaze direction, FIG. 12D shows corresponding inferred CG face images 408 (see FIG. 5) using models trained using models trained using rendering with random eye gaze variations of ±15° pitch and yaw, and FIG. 12E shows corresponding CG output geometry 54 using models trained using rendering with random eye gaze variations of ±15° pitch and yaw. The inventors were unable to observe any noticeable differences in the quality of the geometry results, although there was improvement in the match in eye gaze between the input and decoded images.

All of the results shown in FIGS. 7-11 were obtained without using the optional LIL loss criteria (e.g. LIL loss functions 234, 236 shown in FIG. 3A).

FIG. 13 shows experimental results for modifying the FIG. 3A training scheme to remove both the CCL loss criteria (CCL loss function evaluations 230, 232) and the LIL loss criteria (LIL loss functions 234, 236). Specifically, FIG. 13A shows performance input 52 comprising an actor image, FIG. 13B shows a corresponding output CG geometry 54 using a model trained with no CCL loss functions and non LIL loss functions and FIG. 13C shows a corresponding output CG geometry 54 using a model trained with CCL loss function evaluations 230, 232 having MSE criterion functions, but without LIL loss functions. FIGS. 13B and 13C show that the shape of the mouth is better reproduced by keeping the CCL loss function. The inventors also tested different types of CCL loss functions, including mean square error (MSE), L1 loss and cosine similarity loss and determined that the specific criterion functions of the CCL functions used for CCL loss function evaluations 230, 232 do not have a significant impact on results.

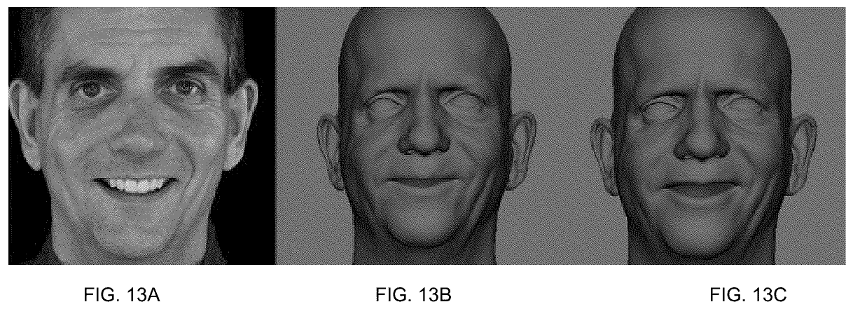

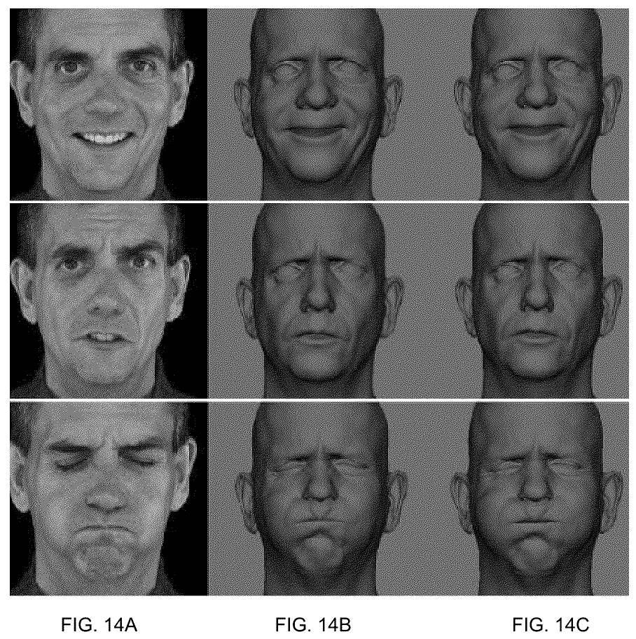

FIG. 14 shows experimental results for modifying the location of the CCL loss function evaluations 230, 232 in the FIG. 3A training scheme 300. In the illustrated FIG. 3A embodiment, the CCL loss function evaluations 230, 232 compare the latent codes (i.e. at the “information bottleneck” or each encoder 20A). The inventors experimented with evaluating the CCL loss functions at the outputs of the one or more initial shared decoder layers 204. FIG. 14A shows performance input 52 comprising actor images, FIG. 14B shows corresponding CG output geometries 54 using CCL loss function evaluations 230, 232 evaluated at the information bottleneck as per the illustrated FIG. 3A training scheme and FIG. 14C shows corresponding CG output geometries 54 using CCL loss functions evaluated at the outputs of the one or more initial shared decoder layers 204. The inventors determined that the differences between these results were minimal.

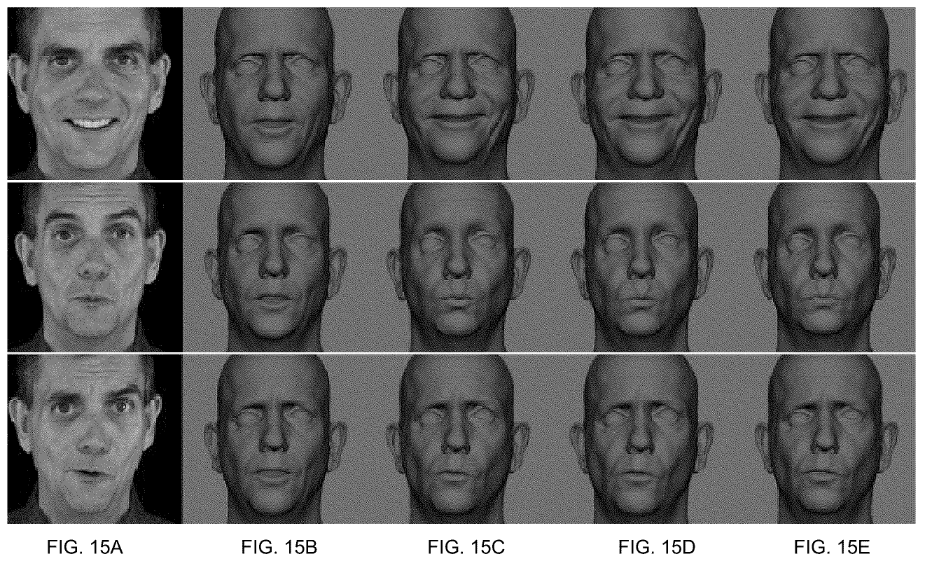

FIG. 15 shows experimental results for modifying the FIG. 4A image-to-geometry training scheme 400 by varying the inputs to, and characteristics of, the image-to-geometry neural network 302 that forms part of the image-to-geometry model 42. Specifically, FIG. 15A shows performance input 52 comprising actor images. FIG. 15B shows corresponding CG output geometries 54 for the case where image-to-geometry neural network 302 was designed as a single fully connected linear layer neural network with its input being the shared bottleneck layer (i.e. latent code 410) shown in FIG. 5. FIG. 15B shows that a single layer regressed from the bottleneck layer (i.e. latent coder 410) is insufficient to faithfully map the facial expressions of performance input 52. FIG. 15C shows corresponding CG output geometries 54 for the case where image-to-geometry neural network 302 was designed as a 2-layer fully connected neural network with its input being the shared bottleneck layer (i.e. latent code 410) shown in FIG. 5 and leaky ReLU activation functions. This structure for image-to-geometry neural network 302 shows improvement in fidelity relative to that of FIG. 15B. FIG. 15D shows corresponding CG output geometries 54 for the case where image-to-geometry neural network 302 was designed as a 3-layer neural network with its input being the shared bottleneck layer (i.e. latent code 410) shown in FIG. 5 and leaky ReLU activation functions. This structure for image-to-geometry neural network 302 shows improvement in fidelity relative to that of FIGS. 15B and 15C. FIG. 15D shows corresponding CG output geometries 54 for the case where image-to-geometry neural network 302 was designed as a single fully-connected layer neural network with linear activation functions with its input being the one or more shared decoder layers 204 shown in FIG. 5—i.e. the illustrated embodiment of FIG. 5, with image-to-geometry neural network 302 comprising a single fully connected layer with linear activation functions. This structure for image-to-geometry neural network 302 shows fidelity similar to that of the structures of FIGS. 15C and 15D.

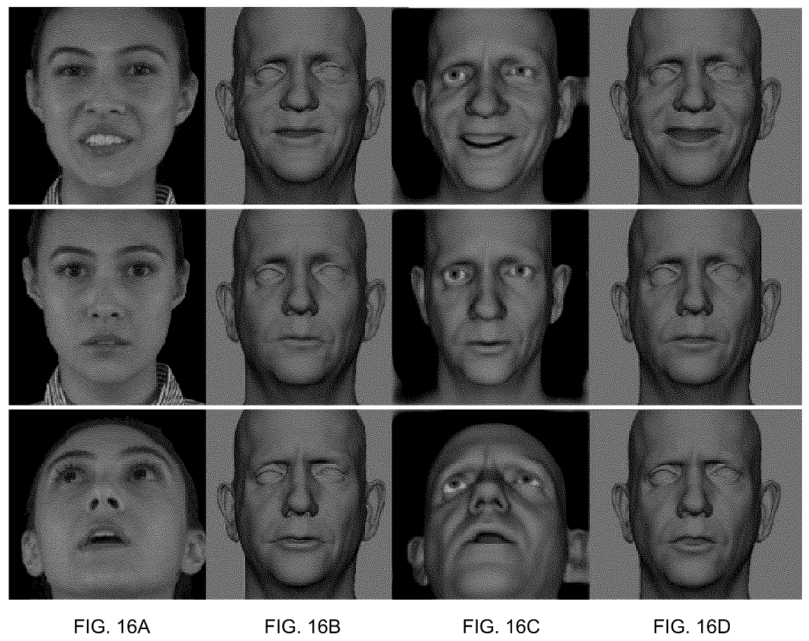

FIG. 16 shows experimental results for modifying the FIG. 5A inference method 400 to remove the latent CG projection. Specifically, FIG. 16A shows performance input 52 comprising actor images; FIG. 16B shows corresponding CG output geometries 54 for the situation where the FIG. 5 inference method 400 is modified so that image-to-geometry neural network 302 receives its input from the one or more shared decoder layers 204** shown in FIG. 5—i.e. without latent projection, FIG. 16C shows corresponding inferred CG face images 408 (see FIG. 5) using the illustrated embodiment shown in FIG. 5—i.e. with latent projection and FIG. 16D shows corresponding CG output geometries 54 using the illustrated embodiment shown in FIG. 5. FIG. 16 shows that the latent projection of the illustrated embodiment of FIG. 5 is beneficial where the CG character does not match the actor particularly well.

The results shown in FIGS. 14-16 were obtained without using the optional LIL loss criteria (e.g. LIL loss functions 234, 236 shown in FIG. 3A).

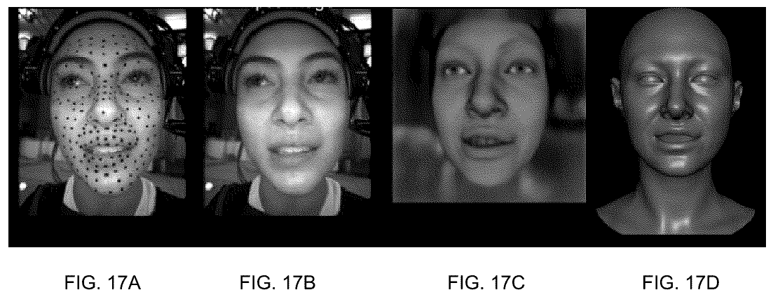

FIG. 17 shows experimental results obtained using the FIG. 1A facial animation transfer method 10 where performance input 52 comprises a performance by an actor captured using an HMC and with markers applied to the face of the actor. The results shown in FIG. 17 were obtained with use the optional LIL loss criteria (e.g. LIL loss functions 234, 236 shown in FIG. 3A). FIG. 17A shows performance input 52 from an actor. FIG. 17B shows the corresponding image with markers removed (e.g. after block 105). FIG. 17C shows the corresponding generated character face (e.g. CG face 408). FIG. 17D shows the corresponding frontal view output 3D geometry (e.g. 3D CG face geometries 54).

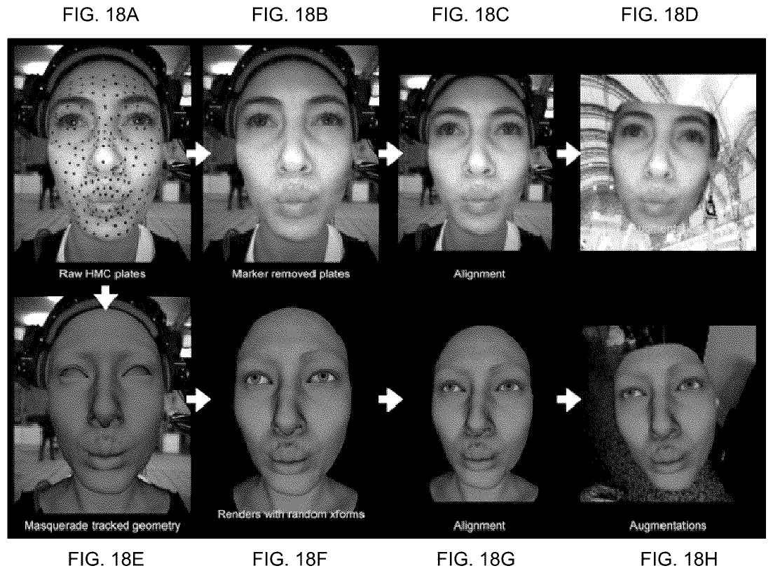

FIG. 18 shows a portion of the intermediate experimental results obtained using the FIG. 1A facial animation transfer method 10. In particular FIG. 18 shows portions of preparing data block 20 and training unpaired image-to-image model(s) 30. FIG. 18A shows input actor images 12 that were taken with an HMC during an actor's performance where the actor had markers applied to their face. FIG. 18B shows the actor images after markers have been removed (e.g. after block 105). FIG. 18C shows an aligned actor face 120. FIG. 18D shows augmented actor face 216. FIG. 18E shows a frame of CG performance dataset 14 where the chosen frame corresponds to the frame of actors images 12 in FIG. 18A. FIG. 18F shows rendered CG-based image 136. FIG. 18G shows aligned CG face 140. FIG. 18H shows augmented CG face 212. In FIGS. 18D and 18H the backgrounds of the images have been changed. The background may be changed in any suitable way. FIGS. 18D and 18H show that the background in CG face 212 may be different from the background in actor face 216. Additionally, while not specifically shown in FIG. 18, if a frame of actor images 12 is used a plurality of times in the training of image-to-image model 30, the background in CG face 212 and/or actor face 216 may vary between training iterations (e.g. the background in a frame of CG face 212 may vary between a first and second iteration of such frame through the training of image-to-image model(s) 30).

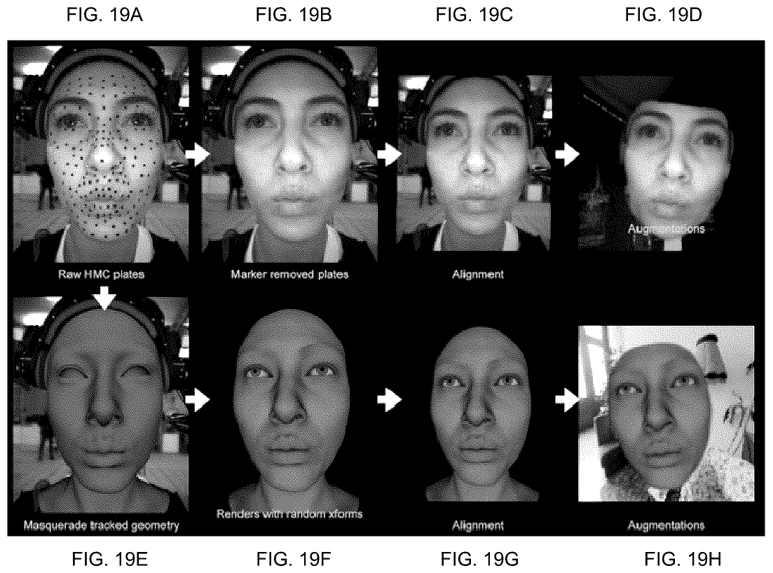

FIG. 19 shows the same portions of the FIG. 1A facial animation transfer method as FIG. 18. Like figure numbering represents like steps in the method. FIGS. 19D and 19H have varying backgrounds in comparison to FIGS. 18D and 18H exemplifying that the background in CG face 212 may be different than the background in actor face 216. Further FIGS. 18D and 19D exemplify that between frames the background of actor face 216 may be different. FIGS. 18H and 19H exemplify that between frames the background of CG face 212 may be different.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Software and other modules may reside on servers, workstations, personal computers, tablet computers, image data encoders, image data decoders, PDAs, color-grading tools, video projectors, audio-visual receivers, displays (such as televisions), digital cinema projectors, media players, and other devices suitable for the purposes described herein. Those skilled in the relevant art will appreciate that aspects of the system can be practised with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics (e.g., video projectors, audio-visual receivers, displays, such as televisions, and the like), set-top boxes, color-grading tools, network PCs, mini-computers, mainframe computers, and the like.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

The invention(s) disclosed herein include a number of non-limiting aspects. Non-limiting aspects of the invention comprise:
1. A method, performed on a computer, for transferring facial expressions from a performance input to a three-dimensional (3D) computer graphics (CG) character, the method comprising:
   providing an inference engine trained for receiving, as input, images exhibiting facial expressions and outputting, for each input image, a 3D CG representation of a CG character having a character facial expression corresponding to the facial expression of the input image;
   receiving performance input, the performance input comprising, or convertible to, one or more performance input images, each of the one or more performance input images exhibiting a performance facial expression;
   inputting the performance input images to the inference engine to thereby infer, for each performance input image, a corresponding 3D CG representation of an output CG character having an inferred character facial expression corresponding to the performance facial expression of the performance input image.
2. The method of aspect 1 or any other aspect herein wherein the inference engine comprises an encoder that is part of an autoencoder, the encoder trained to receive, as input, images exhibiting facial expressions and to compress the input images into corresponding latent codes.
3. The method of aspect 2 or any other aspect herein wherein the encoder is trained using, as training input, training images exhibiting facial expressions from multiple identities and the encoder comprises the same trained parameters for each of the multiple identities.
4. The method of aspect 3 or any other aspect herein wherein at least one of the multiple identities comprises the output CG character.
5. The method of any one of aspects 3 to 4 or any other aspect herein wherein at least one of the multiple identities comprises a source CG character that is different from the output CG character.
6. The method of any one of aspects 3 to 5 or any other aspect herein wherein at least one of the multiple identities comprises an actor (i.e. a real person as opposed to a CG character).
7. The method of any one of aspects 3 to 6 or any other aspect herein wherein the performance input images are from an input identity that is different from the multiple identities used to train the encoder.
8. The method of any one of aspects 3 to 7 or any other aspect herein wherein the inference engine comprises a latent-to-3D network, the latent-to-3D network trained to receive, as input, latent codes (e.g. generated by the encoder or by the encoder in combination with a portion of a decoder that forms part of the autoencoder) and to output, for each latent code, a corresponding 3D CG representation of the output CG character.
9. The method of aspect 8 or any other aspect herein wherein at least a first portion of the latent-to-3D network comprises trained parameters that are specific to the output CG character.
10. The method of aspect 9 or any other aspect herein wherein at least a second portion of the latent-to-3D network comprises the same trained parameters for each of the multiple identities.
11. The method of aspect 10 or any other aspect herein wherein the second portion of the latent-to-3D network comprises at least a portion of a decoder that is part of the autoencoder.
12. The method of any one of aspects 10 to 11 or any other aspect herein wherein:
   the second portion of the latent-to-3D network is trained to receive, as input, latent codes (e.g. generated by the encoder or by the encoder in combination with a portion of a decoder that forms part of the autoencoder); and
   the first portion of the latent-to-3D network comprises an image-to-geometry neural network which is trained to receive, as input, output from the second portion of the latent-to-3D network and to output corresponding 3D CG representations of the output CG character.
13. The method of aspect 12 or any other aspect herein wherein the image-to-geometry neural network is trained at least in part using, as training input, 3D CG training representations (e.g. blendshape weights and/or the like) of the output CG character exhibiting facial expressions of the output CG character.
14. The method of any one of aspects 12 to 13 or any other aspect herein wherein:
   the first portion of the latent-to-3D network comprises a character-specific image-to-image decoder which is part of the autoencoder and which is trained to receive, as input, output from the second portion of the latent-to-3D network and to output corresponding images of the output CG character.
15. The method of aspect 14 or any other aspect herein wherein the character-specific image-to-image decoder is trained at least in part using, as training input, image-to-image training input comprising, or convertible to, a plurality of training input images of the output CG character.
16. The method of any one of aspects 14 to 15 or any other aspect herein wherein the inference engine comprises:
   an image-to-image model which comprises:
      a first instance of the encoder for receiving, as input, images exhibiting facial expressions and compressing the input images into corresponding latent codes;
      a first instance of the second portion of the latent-to-3D network for receiving, as input, latent codes generated by the first instance of the encoder; and
      the character-specific image-to-image decoder for receiving, as input, output from the first instance of the second portion of the latent-to-3D network and outputting corresponding images of the output CG character;
   a second instance of the encoder for receiving, as input, images of the output CG character from the character-specific image-to-image decoder and compressing the images of the output CG character into corresponding latent codes;
   a second instance of the second portion of the latent-to-3D network for receiving, as input, latent codes generated by the second instance of the encoder; and
   the image-to-geometry neural network for receiving, as input, output from the second instance of the second portion of the latent-to-3D network and outputting corresponding 3D CG representations of the output CG character.
17. The method according to any one of aspects 1 to 16 or any other aspect herein wherein the performance input comprises the one or more performance input images and each of the one or more performance input images exhibits the performance facial expression of a human actor.
18. The method according to aspect 17 or any other aspect herein wherein the performance input images comprise facial markers.
19. The method according to aspect 18 or any other aspect herein wherein the inference engine removes the facial markers.
20. The method according to aspect 1 or any other aspect herein wherein:
   the inference engine is trained using, as input, training images exhibiting facial expressions from multiple training identities; and
   the performance input comprises the one or more performance input images and each of the one or more performance input images exhibits the performance facial expression of a human actor, the human actor different from the multiple training identities.
21. The method according to aspect 20 or any other aspect herein wherein the performance input images comprise facial markers.
22. The method according to aspect 21 or any other aspect herein wherein the inference engine removes the facial markers.
23. The method according to any one of aspects 17 to 22 or any other aspect herein wherein the one or more performance images are captured using a single camera, one of multiple cameras of a head-mounted camera (HMC) apparatus or multiple cameras of a HMC apparatus.
24. The method according to any one of aspects 17 to 23 or any other aspect herein wherein the one or more performance images comprise frames of a video sequence.
25. The method according to any one of aspects 1 to 16 or any other aspect herein wherein the performance input comprises the one or more performance input images and each of the one or more performance input images comprises a rendered image of a CG performance character exhibiting the performance facial expression.
26. The method according to aspect 1 or any other aspect herein wherein:
   the inference engine is trained using, as input, training images exhibiting facial expressions from multiple training identities; and
   the performance input comprises the one or more performance input images and each of the one or more performance input images comprises a rendered image of a CG character exhibiting the performance facial expression, the CG performance character different from the multiple training identities.
27. The method according to any one of aspects 1 to 16 or any other aspect herein wherein:
   the performance input comprises one or more poses/frames of a 3D CG representation of a CG performance character;
   the method comprises rendering the one or more poses/frames of the 3D CG representation of the CG performance character to generate the one or more performance input images; and
   each of the one or more performance input images exhibits the performance facial expression of the CG performance character.
28. The method according to aspect 1 or any other aspect herein wherein:
   the inference engine is trained using, as input, training images exhibiting facial expressions from multiple training identities; and
   the performance input comprises one or more poses/frames of a 3D CG representation of a CG performance character;
   the method comprises rendering the one or more poses/frames of the 3D CG representation of the CG performance character to generate the one or more performance input images;
   each of the one or more performance input images exhibits the performance facial expression of the CG performance character; and
   the CG performance character is different from the multiple training identities.
29. The method according to any one of aspects 1 to 28 or any other aspect herein wherein, for each of the performance input images, the corresponding 3D CG representation of the output CG character comprises a set of weights for a blendshape decomposition corresponding to the output CG character.
30. The method according to aspect 29 or any other aspect herein wherein the blendshape decomposition comprises a principal component analysis (PCA) decomposition and the set of weights comprises a set of PCA weights.
31. The method according to any one of aspects 1 to 28 or any other aspect herein wherein, for each of the performance input images, the corresponding 3D CG representation of the output CG character comprises at least one of: a set of data compression parameters used in a data compression technique corresponding to the output CG character, each set of data compression parameters usable to reconstruct 3D vertex positions of the output CG character; and a set of compression parameters used in a neural network for parameterizing poses of the corresponding output CG character, each set of compression parameters usable to reconstruct 3D vertex positions of the output CG character.
32. The method according to aspect 1 or any other aspect herein wherein providing the inference engine comprises training the inference engine.
33. The method according to aspect 32 or any other aspect herein wherein training the inference engine comprises training the inference engine using training input, the training input comprising: source training input comprising, or convertible to, source training images exhibiting facial expressions of one or more source identities; and 3D CG training representations of the output CG character exhibiting facial expressions of the output CG character.
34. The method according to aspect 33 or any other aspect herein wherein each of the one or more performance images exhibits a performance facial expression of a performance identity, the performance identity different from the one or more source identities and different from the output CG character.
35. The method according to any one of aspects 33 to 34 or any other aspect herein wherein the source training input comprises, for at least one of the one or more source identities, a corresponding set of source training images wherein each of the corresponding set of source training images exhibits the facial expression of a human actor.
36. The method according to aspect 35 or any other aspect herein wherein the source training images comprise facial markers.
37. The method according to aspect 36 or any other aspect herein wherein training the inference engine comprises removing the facial markers.
38. The method according to any one of aspects 35 to 37 or any other aspect herein wherein, for the at least one of the one or more source identities, the corresponding set of training images is captured using a single camera, one of multiple cameras of a head-mounted camera (HMC) apparatus or multiple cameras of a HMC apparatus.
39. The method according to any one of aspects 35 to 38 or any other aspect herein wherein, for the at least one of the one or more source identities, the corresponding set of training images comprises frames of a video sequence.
40. The method according to any one of aspects 33 to 39 or any other aspect herein wherein the source training input comprises, for at least one of the one or more source identities, a corresponding set of source training images rendered from a 3D representation of a CG source character wherein each of the corresponding set of source training images exhibits the facial expression of the CG source character.
41. The method according to any one of aspects 33 to 39 or any other aspect herein wherein, for at least one of the one or more source identities:
   the source training input comprises a set of poses/frames of a 3D representation of a source CG character;
   training the inference engine comprises rendering the set of poses/frames of the 3D representation of the source CG character to generate a corresponding set of source training images; and
   each of the corresponding set of source training images exhibits the facial expression of the source CG character.
42. The method according to any one of aspects 33 to 41 or any other aspect herein wherein:
   the 3D CG training representations of the output CG character comprise a set of training poses/frames of the 3D CG representations of the output CG character;
   training the inference engine comprises rendering the set of training poses/frames of the 3D CG representations of the output CG character to generate a corresponding set of output character training images; and
   each of the corresponding set of output character training images exhibits the facial expression of the output CG character.
43. The method according to aspect 42 or any other aspect herein wherein training the inference engine comprises training an image-to-image model using the source training images and the set of output character training images, wherein the image-to-image model, when trained, receives, as input, images exhibiting facial expressions and outputs corresponding images exhibiting facial expressions of the output CG character.
44. The method according to aspect 43 or any other aspect herein wherein training the inference engine comprises training one or more additional image-to-image models using the source training images and the set of output character training images, wherein each of the one or more additional image-to-image models, when trained, receives, as input, images exhibiting facial expressions and outputs corresponding images exhibiting facial expressions of the one or more source identities.
45. The method according to aspect 43 or any other aspect herein wherein training the image-to-image model comprises training a plurality of autoencoders, the plurality of autoencoders comprising an autoencoder for each of the one or more source identities and for the output CG character, each autoencoder comprising:
   an encoder which, when trained, is capable of converting images exhibiting facial expressions to corresponding latent codes; and
   a decoder which, when trained, is capable of converting latent codes to corresponding images exhibiting facial expressions of one of: the one or more source identities or the output CG character.
46. The method according to aspect 45 or any other aspect herein wherein:
   each autoencoder comprises a shared portion and an identity-specific portion;
   the shared portion comprises shared trainable parameters that are the same across the plurality of autoencoders; and
   the identity-specific portions of the autoencoders each comprise identity-specific trainable parameters that are unique for each of the plurality of autoencoders.
47. The method according to aspect 46 or any other aspect herein wherein the shared portion includes the encoder of each of the autoencoders.
48. The method according to aspect 47 or any other aspect herein wherein the shared portion includes one or more initial layers of the decoder of each of the plurality of autoencoders.
49. The method according to any of aspects 45 to 46 or any other aspect herein wherein training the plurality of autoencoders comprises, for each autoencoder:
   inputting to the autoencoder the source training images corresponding to one of the one or more source identities or the output character training images of the output CG character;
   causing the encoder of the autoencoder to compress the input source training images or the output character training images into corresponding latent codes; and
   causing the decoder of the autoencoder to reconstruct reconstructed images corresponding to the latent codes.
50. The method according to aspect 49 or any other aspect herein wherein training the plurality of autoencoders comprises, for each autoencoder, augmenting the source training images or the output character training images prior to inputting the source training images or the output character training images to the autoencoder.
51. The method according to aspect 50 wherein augmenting the source training images or the output character training images comprises one or more of: translation, rotation, scaling and grid distortion.
52. The method according to aspect 50 or 51 or any other aspect herein wherein augmenting the source training images or the output character training images comprises editing factors of variation of the source training images or the output character training images.
53. The method according to any one of aspects 49 to 52 or any other aspect herein wherein training the plurality of autoencoders comprises, for each autoencoder, generating image-losses (IL) based on a IL difference metric between:
   the source training images corresponding to one of the one or more source identities or the output character training images of the output CG character, as optionally augmented in a manner that is the same as the augmentation of the source training images or the output character training images prior to inputting the source training images or the output character training images to the autoencoder or in a manner that is different than the augmentation of the source training images or the output character training images prior to inputting the source training images or the output character training images to the autoencoder; and
   the corresponding reconstructed images reconstructed by the autoencoder.
54. The method according to aspect 53 or any other aspect herein wherein the IL difference metric comprises one or more of: a criterion function based on least absolute deviation (L1 norm) and a criterion function based on a structural similarity index measure (SSIM).
55. The method according to any one of aspects 49 to 54 or any other aspect herein wherein training the plurality of autoencoders comprises, for each autoencoder, generating cycle-consistency-loss (CCL) losses based on a CCL difference metric between:
   the latent codes generated by the encoder of the autoencoder based on the input source training images or the output character training images, as optionally augmented;
   reconstructed latent codes, wherein the reconstructed latent codes are generated by the encoder of the autoencoder based on reconstructed images reconstructed by a different one of the plurality of autoencoders.
56. The method according to any one of aspects 49 to 54 or any other aspect herein wherein training the plurality of autoencoders comprises, for each autoencoder, generating cycle-consistency-loss (CCL) losses based on a CCL difference metric between:
   an intermediate output generated by the encoder of the autoencoder and a shared portion of a decoder of the autoencoder based on the input source training images or the output character training images, as optionally augmented;
   reconstructed intermediate output, wherein the reconstructed intermediate output is generated by the encoder of the autoencoder and the shared portion of the decoder of the autoencoder based on reconstructed images reconstructed by a different one of the plurality of autoencoders.
57. The method according to any one of aspects 55 to 56 or any other aspect herein wherein the different one of the plurality of autoencoders is randomly selected from among the different ones of the plurality of autoencoders.
58. The method according to any one of aspects 55 to 57 or any other aspect herein wherein the CCL difference metric comprises one or more of: a criterion function based on a mean square error (MSE) and a criterion function based on a least square error (L2 norm).
59. The method according to any one of aspects 49 to 58 or any other aspect herein wherein training the plurality of autoencoders comprises, for each autoencoder, generating latent invariance loss (LIL) losses based on an LIL difference metric between:
   the latent codes generated by the encoder of the autoencoder based on the input source training images or the output character training images, as optionally augmented; and
   latently augmented latent codes, wherein the latently augmented latent codes are generated by the encoder of the autoencoder based on input source training images or the output character training images, as optionally augmented, that have undergone latent invariance augmentation, wherein latent invariance augmentation comprises editing one or more factors of variation of the source training images or the output character training images, as optionally augmented, prior to inputting the source training images or the output character training images to the encoder of the autoencoder.
60. The method according to aspect 59 or any other aspect herein wherein the LIL difference metric comprises one or more of: a criterion function based on a mean square error (MSE) and a criterion function based on a least square error (L2 norm)
61. The method according to any one of aspects 46 to 48 or any other aspect herein wherein a number of the plurality of autoencoders is N and training the plurality of autoencoders comprises performing a plurality of successive sets of N iterations of a batch loop, each iteration of the batch loop corresponding to one of the plurality of autoencoders and comprising:
   selecting a sample of k training images from among the source training images or the set of output character training images corresponding to the one of the autoencoders;
   determining at least one loss for the one of the autoencoders based on the sample of k training images;
   determining one or more loss gradients for each of the shared and identity-specific trainable parameters for the one of the autoencoders based on the at least one loss.
62. The method according to aspect 61 or any other aspect herein wherein determining at least one loss for the one of the autoencoders comprises:
   inputting to the one of the autoencoders each of the sample of k training images;
   causing the encoder of the one of the autoencoders to compress each of the sample of k training images into a corresponding latent code; and
   causing the decoder of the one of the autoencoders to reconstruct a reconstructed image for each of the latent codes.
63. The method according to aspect 62 or any other aspect herein wherein determining at least one loss for the one of the autoencoders comprises augmenting the sample of k training images prior to inputting the sample of k training images to the one of the autoencoders.
64. The method according to aspect 63 wherein augmenting the sample of k training images comprises one or more of: translation, rotation, scaling and grid distortion.
65. The method according to any one of aspects 62 to 64 or any other aspect herein wherein determining at least one loss for the one of the autoencoders comprises, for each of the sample of k training images:
   generating an image-loss (IL) based on a IL difference metric between:
      the training image, as optionally augmented in a manner that is the same as the augmentation of the training image prior to inputting the training image to the one of the autoencoders or in a manner that is different than the augmentation of the training image prior to inputting the training image to the one of the autoencoders; and
      a corresponding reconstructed image reconstructed by the one of the autoencoders.
66. The method according to aspect 65 or any other aspect herein comprising, in each iteration of the batch loop, accumulating (e.g. adding or averaging) the IL loss over the sample of k training images.
67. The method according to aspect 66 or any other aspect herein wherein determining the one or more loss gradients for each of the shared and identity-specific trainable parameters for the one of the autoencoders comprises determining a loss gradient for each of the shared and identity-specific trainable parameters based on the accumulated IL loss.
68. The method according to any one of aspects 62 to 67 or any other aspect herein wherein determining at least one loss for the one of the autoencoders comprises, for each of the sample of k training images:
   generating a cycle-consistency-loss (CCL) loss based on a CCL difference metric between:
      a corresponding latent code generated by the encoder of the one of the autoencoders based on training image, as optionally augmented;
      a reconstructed latent code, wherein the reconstructed latent code is generated by the encoder of the one of the autoencoders based on a reconstructed image reconstructed by a different one of the plurality of autoencoders.
69. The method according to any one of aspects 62 to 67 or any other aspect herein wherein determining at least one loss for the one of the autoencoders comprises, for each of the sample of k training images:
   generating a cycle-consistency-loss (CCL) loss based on a CCL difference metric between:
      a corresponding intermediate output generated by the encoder and a shared portion of a decoder of the one of the autoencoders based on training image, as optionally augmented;
      a reconstructed intermediate output, wherein the reconstructed intermediate output is generated by the encoder and the shared portion of the decoder of the one of the autoencoders based on a reconstructed image reconstructed by a different one of the plurality of autoencoders.
70. The method according to any one or aspects 68 to 69 or any other aspect herein comprising, in each iteration of the batch loop, accumulating (e.g. adding or averaging) the CCL loss over the sample of k training images.
71. The method according to aspect 70 or any other aspect herein wherein determining the one or more loss gradients for each of the shared and identity-specific trainable parameters for the one of the autoencoders comprises determining a loss gradient for each of the shared trainable parameters based on the accumulated CCL loss.
72. The method according to aspect 71 or any other aspect herein comprising at least one of: adding the loss gradient for each of the shared trainable parameters based on the accumulated IL loss and the loss gradient for each of the shared trainable parameters based on the accumulated CCL loss; and adding the accumulated IL loss and the accumulated CCL loss to generate a total accumulated loss and determining the one or more loss gradients for each of the shared trainable parameters based on the total accumulated loss.
73. The method according to any one of aspects 62 to 72 or any other aspect herein wherein determining at least one loss for the one of the autoencoders comprises, for each of the sample of k training images:
   generating a latent invariance loss (LIL) based on an LIL difference metric between:
      a corresponding latent code generated by the encoder of the one of the autoencoders based on the training image, as optionally augmented;
      a latent code generated by the encoder of the one of the autoencoders based on the training image, as optionally augmented, that has been augmented to edit one or more factors of variation of the training image.
74. The method according to aspect 73 or any other aspect herein comprising, in each iteration of the batch loop, accumulating (e.g. adding or averaging) the LIL loss over the sample of k training images.
75. The method according to aspect 74 or any other aspect herein wherein determining the one or more loss gradients for each of the shared and identity-specific trainable parameters for the one of the autoencoders comprises determining a loss gradient for each of the shared trainable parameters based on the accumulated LIL loss.
76. The method according to aspect 75 or any other aspect herein comprising at least one of: adding the loss gradient for each of the shared trainable parameters based on the accumulated IL loss, the loss gradient for each of the shared trainable parameters based on the accumulated CCL loss and the loss gradient for each of the shared trainable parameters based on the LIL loss; and adding the accumulated IL loss, the accumulated CCL loss and the accumulated LIL loss to generate a total accumulated loss and determining the one or more loss gradients for each of the shared trainable parameters based on the total accumulated loss.
77. The method according to any one of aspects 61 to 76 or any other aspect herein comprising, after each set of N iterations of the batch loop, updating the shared and identity-specific trainable parameters based on the loss gradients.
78. The method according to any one of aspects 61 to 76 or any other aspect herein comprising, after each set of N iterations of the batch loop, accumulating (e.g. adding or averaging) the loss gradients for the shared trainable parameters determined in each iteration of the batch loop.
79. The method according to aspect 78 or any other aspect herein comprising, after each set of N iterations of the batch loop:
   updating the identity-specific trainable parameters based on the loss gradients; and
   updating the shared trainable parameters based on the accumulated loss gradients for the shared trainable parameters.
80. The method according to any one of aspects 77 to 79 comprising, after updating the trainable and identity-specific trainable parameters, resetting the gradients prior to a next one of the plurality of successive sets of N iterations of a batch loop.
81. The method according to any one of aspects 42 to 80 wherein:
   training the inference engine comprises augmenting the training poses/frames in the set of training poses/frames of the 3D CG representations of the output CG character; and
   rendering the set of training poses/frames of the 3D CG representations of the output character comprises rendering the augmented training poses/frames of the 3D CG representations of the output CG character to generate the corresponding set of output character training images.
82. The method according to aspect 81 or any other aspect herein wherein augmenting the training poses/frames in the set of poses/frames of the 3D CG representations of the output CG character comprises applying one or more head orientation transforms to the set of training poses/frames of the 3D CG representations of the output CG character.
83. The method according to aspect 82 or any other aspect herein wherein the head orientation transforms are based at least in part on samples of head orientations derived from the source training images.
84. The method according to aspect 83 or any other aspect herein wherein the head orientation transforms are generated randomly from among a set of samples of head orientations derived from the source training images.
85. The method according to any one of aspects 81 to 84 or any other aspect herein wherein augmenting the training poses/frames in the set of training poses/frames of the 3D CG representations of the output CG character comprises applying augmentations comprising one of more of: eye transformations, variations in lighting, variations in background (color, luminosity and/or the like), occlusions, lens distortions and field of view augmentations.
86. The method according to any one of aspects 81 to 85 or any other aspect herein wherein augmenting the training poses/frames in the set of training poses/frames of the 3D CG representations of the output CG character comprises applying one or more augmentations that are based at least in part on information sampled from the source training images.
87. The method according to any one of aspects 81 to 86 or any other aspect herein wherein augmenting the training poses/frames in the set of training poses/frames of the 3D CG representations of the output CG character comprises applying one or more augmentations that are, at least partially, random.
88. The method according to any one of aspects 42 to 87 or any other aspect herein wherein training the inference engine comprises training an image-to-geometry model using the set of training poses/frames of the 3D CG representations of the output CG character and the corresponding output character training images, wherein the image-to-geometry model, when trained, receives, as input, images exhibiting facial expressions of the output CG character and outputs corresponding 3D CG representations of the output CG character.
89. The method according to aspect 88 or any other aspect herein wherein the image-to-geometry model comprises an image-to-geometry neural network.
90. The method according to any one of aspects 46 to 87 or any other aspect herein wherein:
   training the inference engine comprises training an image-to-geometry model using the set of training poses/frames of the 3D CG representations of the output CG character and the corresponding output character training images;
   the image-to-geometry model, when trained, receives, as input, images exhibiting facial expressions of the output CG character and outputs corresponding 3D CG representations of the output CG character; and
   the image-to-geometry model comprises:
      the shared portion of the plurality of autoencoders comprising the shared trainable parameters that are the same across the plurality of autoencoders; and
      an image-to-geometry neural network.
91. The method according to aspect 90 or any other aspect herein wherein the inference engine comprises:
   the autoencoder corresponding to the output CG character for receiving performance input images, and for each performance input image, outputting a corresponding image of the output CG character exhibiting the performance facial expression;
   the shared portion of the plurality of autoencoders comprising the shared trainable parameters that are the same across the plurality of autoencoders for receiving the images of the output CG character; and
   the image-to-geometry neural network for receiving output from the shared portion of the plurality of autoencoders and, for each image of the output CG character received by the shared portion of the plurality of autoencoders, outputting the corresponding 3D CG representation of the output CG character having the inferred character facial expression corresponding to the performance facial expression of the performance image.
92. The method according to aspect 90 or any other aspect herein wherein the inference engine comprises:
   the shared portion of the plurality of autoencoders comprising the shared trainable parameters that are the same across the plurality of autoencoders for receiving performance input images; and
   the image-to-geometry neural network for receiving output from the shared portion of the plurality of autoencoders and, for each performance input image received by the shared portion of the plurality of autoencoders, outputting the corresponding 3D CG representation of the output CG character having the inferred character facial expression corresponding to the performance facial expression of the performance image.
93. The method according to any one of aspects 89 to 92 or any other aspect herein wherein the image-to-geometry neural network comprises a fully connected neural network.
94. The method according to any one of aspects 89 to 93 or any other aspect herein wherein the image-to-geometry neural network comprises linear activation functions.
95. The method according to any one of aspects 88 to 94 or any other aspect herein wherein the set of training poses/frames of the 3D CG representations of the output CG character comprises, for each training pose/frame, a set of weights for a blendshape decomposition corresponding to the output CG character and wherein training the image-to-geometry model comprises at least one of: performing the blendshape decomposition to determine the weights for each training pose/frame; and receiving the blendshape decomposition and the weights for each training pose/frame.
96. The method according to aspect 95 wherein the blendshape decomposition comprises a principal component analysis (PCA) decomposition and the set of weights comprises a set of PCA weights.
97. The method according to any one of aspects 88 to 94 or any other aspect herein wherein the set of training poses/frames of the 3D CG representations of the output CG character comprises, for each training pose/frame, at least one of: a set of data compression parameters used in a data compression technique corresponding to the output CG character, each set of data compression parameters usable to reconstruct 3D vertex positions of the output CG character; and a set of neural network parameters used in a neural network for parameterizing poses of the corresponding output CG character, each set of neural network parameters usable to reconstruct 3D vertex positions of the output CG character.
98. A method, performed on a computer, for transferring facial expressions from a performance input to a three-dimensional (3D) computer graphics (CG) character, the method comprising iteratively performing the method as described in any one of aspects 1 to 97 until it is determined that the 3D CG character is sufficient.
99. The method according to aspect 98 further comprising integrating the performance input wholly or partially into training data of the inference engine.
100. The method according to any one of aspects 98 to 100 wherein training data comprises a 3D representation of a CG performance character.
101. A method, performed on a computer, for training an inference engine to transfer facial expressions from a performance input to a three-dimensional (3D) computer graphics (CG) character, the performance input comprising, or convertible to, one or more performance input images, each of the one or more performance input images exhibiting a performance facial expression, the inference engine, when trained, capable of inferring, for each of the performance input images, a corresponding 3D CG representation of an output CG character having an inferred character facial expression corresponding to the performance facial expression of the performance input image, the method comprising:
   training the inference engine using training input, the training input comprising: source training input comprising, or convertible to, source training images exhibiting facial expressions of one or more source identities; and 3D CG training representations of the output CG character exhibiting facial expressions of the output CG character.
102. A method according to aspect 101 comprising any of the features, combinations of features or sub-combinations of features of any of aspects 1 to 100.
103. A system comprising one or more processors configured to perform the methods of any of aspects 1 to 102.
104. A computer program product comprising a computer-readable medium on which are encoded instructions which, when executed by one or more suitable processors, cause the processors to perform the methods of any of aspects 1 to 102.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method, performed on a computer, for transferring facial expressions from a performance input to a three-dimensional (3D) computer graphics (CG) character, the method comprising:
providing an inference engine trained for receiving, as input, images exhibiting facial expressions and outputting, for each input image, a 3D CG representation of a CG character having a character facial expression corresponding to the facial expression of the input image;
receiving performance input, the performance input comprising, or convertible to, one or more performance input images, each of the one or more performance input images exhibiting a performance facial expression;
inputting the performance input images to the inference engine to thereby infer, for each performance input image, a corresponding 3D CG representation of an output CG character having an inferred character facial expression corresponding to the performance facial expression of the performance input image.

2. The method of claim 1 wherein the inference engine comprises an encoder that is part of an autoencoder, the encoder trained to receive, as input, images exhibiting facial expressions and to compress the input images into corresponding latent codes.

3. The method of claim 2 wherein the encoder is trained using, as training input, training images exhibiting facial expressions from multiple identities and the encoder comprises the same trained parameters for each of the multiple identities.

4. The method of claim 3 wherein at least one of the multiple identities comprises the output CG character.

5. The method of claim 3 wherein at least one of the multiple identities comprises a source CG character that is different from the output CG character.

6. The method of claim 3 wherein at least one of the multiple identities comprises an actor (i.e. a real person as opposed to a CG character).

7. The method of claim 3 wherein the performance input images are from an input identity that is different from the multiple identities used to train the encoder.

8. The method of claim 3 wherein the inference engine comprises a latent-to-3D network, the latent-to-3D network trained to receive, as input, latent codes (e.g. generated by the encoder or by the encoder in combination with a portion of a decoder that forms part of the autoencoder) and to output, for each latent code, a corresponding 3D CG representation of the output CG character.

9. The method of claim 8 wherein at least a first portion of the latent-to-3D network comprises trained parameters that are specific to the output CG character.

10. The method of claim 9 wherein at least a second portion of the latent-to-3D network comprises the same trained parameters for each of the multiple identities.

11. The method of claim 10 wherein the second portion of the latent-to-3D network comprises at least a portion of a decoder that is part of the autoencoder.

12. The method of claim 10 wherein:
the second portion of the latent-to-3D network is trained to receive, as input, latent codes (e.g. generated by the encoder or by the encoder in combination with a portion of a decoder that forms part of the autoencoder); and
the first portion of the latent-to-3D network comprises an image-to-geometry neural network which is trained to receive, as input, output from the second portion of the latent-to-3D network and to output corresponding 3D CG representations of the output CG character.

13. The method of claim 12 wherein the image-to-geometry neural network is trained at least in part using, as training input, 3D CG training representations (e.g. blendshape weights and/or the like) of the output CG character exhibiting facial expressions of the output CG character.

14. The method of claim 12 wherein:
the first portion of the latent-to-3D network comprises a character-specific image-to-image decoder which is part of the autoencoder and which is trained to receive, as input, output from the second portion of the latent-to-3D network and to output corresponding images of the output CG character.

15. The method of claim 14 wherein the character-specific image-to-image decoder is trained at least in part using, as training input, image-to-image training input comprising, or convertible to, a plurality of training input images of the output CG character.

16. The method of claim 14 wherein the inference engine comprises:
an image-to-image model which comprises:
a first instance of the encoder for receiving, as input, images exhibiting facial expressions and compressing the input images into corresponding latent codes;
a first instance of the second portion of the latent-to-3D network for receiving, as input, latent codes generated by the first instance of the encoder; and
the character-specific image-to-image decoder for receiving, as input, output from the first instance of the second portion of the latent-to-3D network and outputting corresponding images of the output CG character;
a second instance of the encoder for receiving, as input, images of the output CG character from the character-specific image-to-image decoder and compressing the images of the output CG character into corresponding latent codes;
a second instance of the second portion of the latent-to-3D network for receiving, as input, latent codes generated by the second instance of the encoder; and
the image-to-geometry neural network for receiving, as input, output from the second instance of the second portion of the latent-to-3D network and outputting corresponding 3D CG representations of the output CG character.

17. The method according to claim 1 wherein the performance input comprises the one or more performance input images and each of the one or more performance input images exhibits the performance facial expression of a human actor.

18. The method according to claim 17 wherein the performance input images comprise facial markers.

19. The method according to claim 18 wherein the inference engine removes the facial markers.

20. The method according to claim 1 wherein:
the inference engine is trained using, as input, training images exhibiting facial expressions from multiple training identities; and
the performance input comprises the one or more performance input images and each of the one or more performance input images exhibits the performance facial expression of a human actor, the human actor different from the multiple training identities.
